(19) United States
(12) Patent Application Publication
(10) Pub. No.: US 2009/0282872 A1
(43) Pub. Date: Nov. 19, 2009

(54) Molten Glass Supply Apparatus and Process for Producing Glass Formed Article

(76) Inventors: Masahiro Tomamoto, Shiga (JP); Hidetaka Oda, Shiga (JP); Noritomo Nishiura, Shiga (JP)

Correspondence Address: WENDEROTH, LIND & PONACK, L.L.P., 1030 15th Street, N.W.,, Suite 400 East, Washington, DC, 20005-1503, US

(21) Appl. No.: 12/085,307

(22) PCT Filed: Dec. 12, 2006
(86) PCT No.: PCT/JP2006/324718

§ 371 Date: May 21, 2008

(30) Foreign Application Priority Data
Jan. 5, 2006 (JP) 2006-00860
Jan. 5, 2006 (JP) 2006-000862
Jan. 5, 2006 (JP) 2006-000865

(51) Int. Cl. C03B 35/00; C03B 5/18

(52) U.S. Cl. 65/66; 65/179

(57) ABSTRACT

A molten glass supply apparatus including a plurality of stirring vessels (K1, K2) disposed adjacent to each other in the upstream and downstream direction along supply passage (4) for supply of molten glass having flowed out from melting furnace (2) as a molten glass supply source to forming device (3), in which among at least two agitation vessels (K1, K2) disposed adjacent to each other, at least one of upper portion and lower portion of upstream side stirring vessel (K1) is provided with an inflow opening (M1) while the other portion is provided with an outflow opening (N1), and an inflow opening (M2) and an outflow opening (N2) of the downstream side stirring vessel (K2) are provided so that upper and lower portions are the same as the upstream side stirring vessel (K1), and the outflow aperture (N1) of the upstream side stirring vessel (K1) is connected through a communicating passage (R1) to the inflow opening (M2) of the downstream side stirring vessel (K2) whose upper and lower portions are upside-down to the outflow opening.

### TECHNICAL FIELD

The present invention relates to a molten glass supply apparatus and a process for production of a glass formed article. More specifically, the present invention relates to improvement of a supply passage for supplying a molten glass to a forming device from a melting furnace and improvement of a technology of producing a glass formed article by supplying the molten glass to the forming device from the melting furnace through the supply passage.

### BACKGROUND OF THE INVENTION

In recent years, demand for a glass substrate for a flat-surface display typified by liquid crystal display (LCD) and electroluminescence display (ELD); a cover glass for various image sensors, such as a charge-coupled device (CCD), an equal-size contact solid-state image sensor (CIS), and a CMOS image sensor, and a laser diode; and a glass substrate for a hard disk and a filter has rapidly expanded.

In contrast, a glass which has been conventionally used for forming articles such as an optical glass, a plate glass for windows, a bottle, and a tableware and the like articles is widely known as a so-called low viscosity glass. The above-mentioned high viscosity glass is remarkably different from the low viscosity glass in the properties. To be specific, the high viscosity glass typified by alkali free glass for liquid crystal displays shows property that when a viscosity is 1,000 poise, a temperature equivalent to the viscosity is 1,350° C. or higher and, in an especially high viscosity glass, 1,420° C. or higher as described in the following Patent Document 1. In contrast, the low viscosity glass typified by soda lime glass for containers shows property that when a viscosity is 1,000 poise, a temperature equivalent to the viscosity is 1,250° C. or lower and, in an especially low viscosity glass, 1,200° C. or lower. Therefore, the high viscosity glass and the low viscosity glass can be distinguished from each other as different glasses based on the relationship between temperatures and viscosities.

When producing an article formed of the above-mentioned high viscosity glass, a molten glass formed of a high viscosity glass is supplied to a forming device, and, for example, a sheet glass or the like used as a glass panel for liquid crystal displays is formed in the forming device. Therefore, when producing such an article, a molten glass supply apparatus is used, which is equipped with a supply passage only for a high viscosity glass, for supplying to a forming device, a molten glass, which has flowed out of a melting furnace serving as a supply source of the molten glass. Moreover, when also producing, for example, a plate glass for windows or bottles formed of a low viscosity glass, a molten glass supply apparatus is used, which is equipped with a supply passage only for a low viscosity glass, for supplying to a forming device, a molten glass which has flowed out of a melting furnace. However, such a molten glass supply device does not have durability against high temperatures. Therefore, the molten glass supply apparatus is also classified into an apparatus only for a high viscosity glass and as an apparatus only for a low viscosity glass.

In this case, in the melting furnace in the molten glass supply apparatus only for a high viscosity glass, a heterogeneous phase having a low specific gravity may be formed on a surface portion of a molten glass in a melting furnace due to that, for example, a glass raw material is not appropriately melted (e.g., melt separation), or a heterogeneous phase having a high specific gravity is formed on a bottom portion of a molten glass in a melting furnace due to that, for example, a refractory (e.g., high zirconia refractory) which forms an inner wall of a melting furnace is eroded. When such a molten glass flows out of the melting furnace, and the molten glass as it is supplied to the forming device through the supply passage, quality degradation due to the existence of the heterogeneous phase occurs in a glass formed article produced in the forming device. For example, when a glass formed article is a sheet glass, quality degradation is caused by the formation of irregularities on a glass surface due to the heterogeneous phase, whereby defectives are frequently formed.

Moreover, in the melting furnace in the molten glass supply apparatus only for a low viscosity glass, a heterogeneous phase having the above-mentioned composition or type is not formed, and thus such a problem with the heterogeneous phase is not serious. However, since the molten glass is different in temperatures between the bottom portion and the front surface portion, a difference arises in the flowability, which may cause a difference in the quality between the front surface portion and the bottom portion of the molten glass. Then, since there is a possibility that the homogeneity of the quality of a glass formed article may be impeded due to the differences. Therefore, especially in crystal glass products and the like in which quality is severely demanded, the difference in the flowability between the bottom portion and the front surface portion of the molten glass and the like may be a fatal defect.

In view of the above-described circumstances, a stirring vessel is provided on the way of the supply passage only for a high viscosity glass in the molten glass supply apparatus for the purpose of eliminating the heterogeneous phase of the molten glass to obtain a homogeneous molten glass. Conventionally, the number of the stirring vessels provided on the way of the supply passage only for a high viscosity glass was usually only one as described in the following Patent Documents 2, 3, and 4. In contrast, the following Patent Document 5 discloses a structure in which a first stirring circulation means having a stirrer is provided at the downstream end of a cooling vessel; a second stirring circulation means and a third stirring circulation means each having a screw are provided at the upstream end and the downstream end of a vacuum degassing vessel; and a fourth stirring circulation means having a blade is provided at the upstream end of a homogenization vessel.

In contrast, the following Patent Document 6 and Patent Document 7 each disclose a structure in which a plurality of stirring circulation means are provided on the way of a supply passage only for a low viscosity glass for supplying a low viscosity molten glass which has a glass viscosity of 650 poise (equivalent to 1,200° C.) at the time of stirring, and which is formed of soda lime glass or lead crystal glass. Moreover, the following Patent Document 8 discloses a structure in which one defoaming stirring vessel is provided on the way of a supply passage only for a low viscosity glass for producing a conventional optical glass, a plate glass (understood as a plate glass for windows), a bottle glass, etc., in detail, between the melting furnace and a fining vessel, and two stirring vessels such as a homogenization stirring vessel and a temperature control vessel are provided at the downstream of the fining vessel.

Patent Document 1: JP 2004-262745 A

Patent Document 2: JP 2005-511462 A

Patent Document 3: US 2004-0177649 A

Patent Document 4: JP 2005-60215 A

Patent Document 5: JP 05-208830 A

Patent Document 6: JP 43-12885 B

Patent Document 7: JP 63-8226 A

Patent Document 8: JP 60-27614 A

### DISCLOSURE OF THE INVENTION

### Problems to be Solved by the Invention

In recent years, increase in the size of a sheet glass for, for example, liquid crystal displays has been promoted, and improvement in productivity of a glass formed article made of another high viscosity glass has been attempted. Accompanied with this, a flow amount per unit time of a molten glass to be supplied to a forming device through a supply passage only for a high viscosity glass has rapidly increased. In order to eliminate the above-described heterogeneous phase to homogenize a molten glass, the stirring ability of a stirring vessel needs to be increased when the flow amount of a molten glass increases as described above. Then, the inventors of the present invention have attempted to increase the rotation number of a stirring blade so as to meet such a request. However, since the molten glass is of high viscosity, increasing the rotation number of the stirring blade in the molten glass results in increase in load to a stirring means (stirrer) body, which becomes a factor of fatal troubles such as breakage. Further, resistance which acts on the stirring blade becomes inappropriately large, and thus the stirring blade is chipped, and thus, the chipped foreign matter (usually platinum) is mixed in the molten glass. Then, the foreign matter causes defects in a glass formed article. Moreover, in order to reduce the resistance to the stirring blade, an operation at higher temperatures is conceivable. However, according to such a process, mechanical strength of platinum as material of the stirring blade becomes insufficient, which leads to a conclusion that the same problem arises.

The above-mentioned Patent Document 2 proposes improving the shape of the stirring blade to thereby decrease the chipped amount of a noble-metal foreign matter as another measure for dealing with such a kind of problem. However, under the restrictions in which the stirring blade needs to be rotated in a high viscosity molten glass, even such a measure has limitations. Thus, such a measure cannot deal with the sharp increase in the flow amount of a molten glass in recent years.

Due to the above-described circumstances, when the above-described problem with the increase in the flow amount occurred in the supply passage only for a high viscosity glass, such a problem was merely tried to be solved only by separately further providing a set of facilities including a melting furnace, a supply passage, and a forming device.

In the above-mentioned Patent Document 5, a first circulation portion having a stirrer, a second circulation portion and a third circulation portion each having a screw, and a fourth circulation portion having a blade are provided on the way of a supply passage only for a high viscosity glass. The first circulation portion converts, to a foam, an occluded gas contained in a molten glass in a previous step of homogenizing the molten glass by stirring, and both the second and third circulation portions push downward the molten glass which intends to rise. Thus, since only the fourth circulation portion homogenizes a molten glass, it is extremely difficult to eliminate the above-mentioned heterogeneous phase to thereby sufficiently homogenize the molten glass even by the process of Patent Document 5. As a result, also in this case, in order to deal with the sharp increase in the flow amount of a molten glass in recent years, a set of facilities including a supply passage, a melting furnace, and a forming device whose structures are the same as those disclosed in Patent Document 5 needs to be separately further provided thereto.

In contrast, in the supply passage only for a low viscosity glass, resistance caused by the rotation of the stirring blade is much lower as compared with the above-described case of the high viscosity glass, and the temperature of molten glass is low. Therefore, even in a case where a necessity of increasing the flow amount of a molten glass arises, problems with breakage of a stirrer, and quality degradation and yield degradation of a glass formed article due to chipping of the stirring blade do not arise.

Therefore, problems with the existence of the heterogeneous phase, breakage of the stirrer, chipping of the stirring blade, etc., which arise when it has been attempted to increase the flow amount of a molten glass are peculiar to the supply passage only for a high viscosity glass. More specifically, since the high viscosity molten glass which flows through this supply passage has properties that the flowability is impeded due to even a slight decrease in the temperature, and stirring by the stirring blade readily becomes difficult, it is presumed that changing the fundamental structure of the existing supply passage is not preferred. Therefore, with respect to the above-mentioned supply passage only for a high viscosity glass disclosed in Patent Document 5, a new vessel is not provided, and a part of an existing vessel is merely reformed. In view of the above-described matters, in order to deal with the increase in the flow amount of a molten glass, it was considered to be optimal to take a measure of separately further providing a set of facilities as described above.

In contrast, in the supply passage only for a low viscosity glass, even when some temperature changes occur, the flowability of a molten glass is not adversely effected. Therefore, the fundamental structure of the supply passage can be readily changed. Thus, various types and numbers of vessels are provided on the supply passage only for a low viscosity glass in the above-mentioned Patent Documents 6, 7, and 8. However, it is considered to be inevitable in the field of producing a glass formed article made of a high viscosity glass that, when such a structure is adopted, the flowability of a molten glass is degraded to thereby cause noticeable defects in a forming operation with a forming device, especially in a glass formed article, and such an idea is accepted as a common sense. Thus, when attention is paid to the structure of the supply passage only for a high viscosity glass, an effective measure for dealing with the increase in the flow amount of a molten glass is not taken at all under the actual circumstances.

A first object of the present invention is to prevent the problems with quality degradation and yield degradation in a glass formed article resulting from the existence of a heterogeneous phase and chipping of the stirring blade by effectively improving the supply passage only for a high viscosity glass, which has been conventionally impossible, even when there is a request of sharply increasing the flow amount of a molten glass.

Moreover, in the above-mentioned Patent Document 5, the supply passage only for a high viscosity glass is provided with the first to fourth circulation portions for stirring. Any of these stirring circulation portions are formed as parts of a cooling vessel, a vacuum degassing vessel, and a homogenization vessel. Thus, since the stirring circulation portion cannot be dealt with as an independent part, maintenance inspection, repair, exchanging, etc., become troublesome and complicated. Also when the temperature of the stirring circulation portion is controlled so as to suitably control the resistance which acts on the stirring blade, etc. by the molten glass, the stirring circulation portion is influenced by the whole vessel. Thus, there is a possibility that the temperature control of the molten glass which flows through the stirring circulation portion may become difficult, and especially it may become difficult to suitably control the viscosity.

Such a problem, especially the problem with the difficulty of suitably controlling a viscosity are peculiar to the supply passage only for a high viscosity glass, and cannot occur in the supply passage only for a low viscosity glass. More specifically, as previously described, since the fundamental structure of the supply passage only for a low viscosity glass can be relatively freely changed, various types and numbers of vessels are provided in the supply passage only for a low viscosity glass of the above-mentioned Patent Documents 6, 7, and 8. However, adopting such a structure in the field of a high viscosity glass inevitably causes fatal defects in a forming operation with a forming device and in a glass formed article. Therefore, with respect to the structure of the supply passage only for a high viscosity glass, an effective measure for dealing with the problems is not taken at all under the actual circumstances.

Then, a second object of the present invention is to facilitate maintenance inspection, repair, or exchanging of the stirring circulation portion, and readily suitably control the resistance of a molten glass which acts on the stirring blade by effectively improving the supply passage only for a high viscosity glass, which has been conventionally impossible.

In contrast, two adjacent stirring circulation portions in the supply passage only for a low viscosity glass disclosed in Patent Documents 7 and 8 among the above-mentioned patent documents are structured so that a molten glass flows into an inflow part formed at a lower portion of the stirring circulation portion at the downstream side from an outflow part formed at a lower portion of the stirring circulation portion at the upstream side through a communicating passage. Moreover, a total of four stirring circulation portions provided at the supply passage only for a high viscosity glass disclosed in Patent Document 5 are structured so that, in the descending order from the upstream side, a molten glass which has flowed into an inflow opening formed at a lower portion of the second stirring circulation portion from an outflow opening formed at a lower portion of the first stirring circulation portion through a communicating passage, passes through the inside of a vacuum degassing vessel, and flows into an inflow opening formed at a lower portion of the fourth stirring circulation portion from an outflow opening formed at a lower portion of the third stirring circulation portion through a communicating passage. In this case, all of the stirring circulation portions each exist as a part of the vessel.

Thus, when the two stirring circulation portions which are adjacent to each other in the upstream and downstream directions have a communicating structure in which the stirring circulation portion at the upstream side is communicated with the stirring circulation portion at the downstream side to thereby flow a molten glass, and all of the stirring circulation portions each exist as a part of a vessel, the molten glass which flows through the whole vessel have influences, due to the synergetic effect, on the molten glass which flows through each stirring circulation portion which is a part of a vessel and the communicating passage for the lower portions of the stirring circulation portions in the case where the flow amount of a molten glass sharply increases. Thus, it can be assumed that it is extremely difficult to supply a molten glass to a forming device while homogenizing the molten glass as requested.

Moreover, the communicating structure of two adjacent stirring vessels in the supply passage only for a low viscosity glass disclosed in Patent Document 6 is a structure in which a molten glass is flowed out of a outflow opening of a stirring vessel at the upstream side in which an inflow opening and an outflow opening are formed at the center in the upstream and downstream directions into an inflow opening at a stirring vessel at the downstream side in which an inflow opening and an outflow opening are similarly formed at the center in the upstream and downstream directions through a communicating passage. However, with the communicating structure, when the flow amount of the molten glass per unit time increases, the flow rate also increases. Therefore, in both the stirring vessels at the upstream side and the downstream side, the molten glass which flows through the center portion in the upstream and downstream directions from the inflow opening to the outflow opening becomes a main stream. This may cause a fatal problem that the flow of the molten glass is stagnated in the upper portion and the lower portion of each stirring vessel.

A third object of the present invention is to form an appropriate communicating structure of a plurality of stirring vessels provided on the way of the supply passage to thereby make it possible to perform sufficient stirring action, and then prevent problems with quality degradation in a glass formed article and yield degradation due to the presence of the heterogeneous phase even when the flow amount of a molten glass is requested to increase.

Moreover, a fourth object of the present invention is to form an appropriate communicating structure of a plurality of stirring vessels provided on the way of the supply passage to thereby make it possible to facilitate maintenance inspection, repair, and exchanging of the stirring vessel, and then prevent problems with quality degradation in a glass formed article and yield degradation by preventing the stirring action from being inappropriately impaired even when the flow amount of a molten glass (both a high viscosity glass and a low viscosity glass) is requested to increase.

### Means for Solving the Problems

A first means to solve the first object of the present invention is a molten glass supply apparatus including a melting furnace serving as a supply source of a molten glass, and a supply passage for supplying a molten glass which has flowed out of the melting furnace to a forming device, is characterized in that the molten glass has such a property that a temperature equivalent to a viscosity of 1,000 poise is 1,350° C. or higher, and a plurality of stirring vessels for conducting homogenization are disposed adjacent to each other in an upstream direction and in a downstream direction on the way of the supply passage.

In this case, the above-mentioned “a plurality of stirring vessels are disposed adjacent to each other in the upstream and downstream directions” as used herein should be understood as that the adjacent stirring vessels are deposited so that there is no vessel between the adjacent stirring vessels. There is no limitation on the communicating state between the adjacent stirring vessels. It is preferred that the adjacent stirring vessels be directly communicated with each other, i.e., the adjacent stirring vessels be connected only by a communicating passage which mainly functions as a passage. It should be noted that, with respect to the communicating passage, providing a baffle plate on the way of the communicating passage is not excluded. Moreover, it is preferred for the passage area of the communicating passage to be smaller than the passage area of the stirring vessel.

Here, the supply target of the apparatus is a molten glass having property that a temperature equivalent to a viscosity of 1,000 poise is 1,350° C. or higher. Thus, the glass is a high viscosity glass, and is distinguished from a low viscosity glass as is clear from the already described matters. When the molten glass is a glass having property that a temperature equivalent to a viscosity of 1,000 poise is 1,420° C. or higher, such a glass is advantageous in that the glass can be distinguished from a low viscosity glass more clearly. As such a high viscosity glass mentioned above, alkali free glass (glass containing an alkali component of 0.1 mass % or lower, particularly 0.05 mass % or lower) can be mentioned as an example. To be specific, based on mass %, alkali free glass containing 40 to 70% SiO₂, 6 to 25% Al₂O₃, 5 to 20% B₂O₃, 0 to 10% MgO, 0 to 15% CaO, 0 to 30% BaO, 0 to 10% SrO, 0 to 10% ZnO, and 0 to 5% fining agents is mentioned. More preferably, alkali free glass containing 55 to 70% SiO₂, 10 to 20% Al₂O₃, 5 to 15% B₂O₃, 0 to 5% MgO, 0 to 10% CaO, 0 to 15% BaO, 0 to 10% SrO, 0 to 5% ZnO, and 0 to 3% fining agents is mentioned.

According to such a structure, a plurality of stirring vessels which conduct homogenization (hereinafter, a stirring vessel which conducts a homogenization action is sometimes referred to as a homogenization vessel) are disposed adjacent to each other in the upstream and downstream directions on the supply passage only for a high viscosity glass. Therefore, even in the case where the flow amount per unit time of the molten glass to be supplied to the forming device through the supply passage increases so as to deal with, for example, increase in the size of a sheet glass for liquid crystal displays and improvement in productivity of another glass formed article made of a high viscosity glass, the stirring ability, especially, the homogenization ability, is increased because the molten glass passes through a plurality of homogenization vessels. Thus, a high viscosity molten glass can be sufficiently homogenized by appropriately eliminating a heterogeneous phase, which is formed due to the fact that a glass is of high viscosity, e.g., the previously-described two kinds of heterogeneous phases of a heterogeneous phase having a low specific gravity on the front surface portion and a heterogeneous phase having a high specific gravity on the bottom portion. As a result, quality degradation (e.g., formation of irregularities caused by the existence of the heterogeneous phase in the case where a glass formed article is a sheet glass) in the glass formed article due to the existence of the heterogeneous phase in the molten glass to be supplied to the forming device is effectively avoided. Moreover, when there exist a plurality of homogenization vessels, a total stirring ability (homogenization ability) can be sufficiently increased without increasing the rotation number of the stirring blade per homogenizing vessel. Thus, the homogenizing effect can be remarkably increased while maintaining a low resistance, which acts on the stirring blade from a high viscosity molten glass. Thus, the problem that the stirring blade is chipped due to resistance of a high viscosity molten glass, and the chipped foreign matter (platinum or the like) is mixed in a molten glass, which causes a fatal defect in a glass formed article, is effectively suppressed. The above-described advantages are enjoyable just because a supply passage only for a high viscosity glass is employed. In a supply passage only for a low viscosity glass, since problems equivalent to the above-described problems do not occur, it is a matter of course that the above-described advantages are not enjoyable.

A second means to solve the second object of the present invention is a molten glass supply apparatus including a melting furnace serving as a supply source of a molten glass, and a supply passage for supplying a molten glass which has flowed out of the melting furnace to a forming device, in which the molten glass has property that a temperature equivalent to a viscosity of 1,000 poise is 1,350° C. or higher, and a plurality of stirring vessels, which are provided separately and independently, are disposed adjacent to each other in an upstream direction and in a downstream direction on the way of the supply passage.

The above-mentioned “a plurality of stirring vessels which are provided separately and independently” as used herein should be understood as that a part which conducts a stirring action does not exist as a part of a vessel and all of vessels each are structured to conduct a stirring action. The second means is different from the first means in that a plurality of stirring vessels, which are provided separately and independently, are disposed adjacent to each other in the upstream and downstream directions on the way of the supply passage only for a high viscosity glass. Since other components and various matters concerning other components are the same as the matters already described according to the first means, the description thereof is omitted here for convenience.

According to the second means, since a plurality of stirring vessels, which are provided separately and independently, are provided on the way of the supply passage only for a high viscosity glass, each stirring vessel can be independently dealt with, thereby easily and simply conduct maintenance inspection, repair, exchanging, etc. Moreover, also when controlling the temperature of the stirring portion so as to appropriately control resistance which acts on the stirring blade from a molten glass, the stirring portion in each vessel is less susceptible to influences of other portions as compared with a conventional supply passage (the above-mentioned supply passage only for a high viscosity glass disclosed in Patent Document 5). The temperature control, especially the viscosity control, of a molten glass which flows through the stirring portion (stirring vessel) can be readily and properly conducted. Also in this case, the above-described advantages, especially the advantages in the viscosity control, are enjoyable just because a supply passage only for a high viscosity glass is employed. In a supply passage only for a low viscosity glass, since problems equivalent to the above-described problems do not occur, it is a matter of course that the above-described advantages are not enjoyable.

In the first and second means, all of the plurality of stirring vessels are structured preferably so that a molten glass immediately after flowing into the stirring vessel from an inflow opening of the stirring vessel is brought into contact with a stirring blade accommodated in the stirring vessel.

Thus, immediately after the molten glass flows into a stirring vessel, the molten glass is brought into contact with a stirring blade to thereby receive a stirring action. Further, since such an action is conducted in all of the plurality of vessels, the stirring ability can be efficiently improved.

In a case of such a structure, it is preferred that a part of the molten glass immediately after flowing into the stirring vessel from the inflow opening be brought into contact with the stirring blade and a remaining portion of the molten glass flow into a portion opposite to a forward direction of flow of the molten glass rather than the stirring blade.

Thus, immediately after the molten glass flows into the stirring vessel, a part of the molten glass is brought into contact with the stirring blade to thereby receive a stirring action, and a remaining portion is brought into contact with the stirring blade to thereby capable of receiving a stirring action for a while after flowing into the stirring vessel. Then, the amount of a molten glass which passes through without contacting the stirring blade is reduced as much as possible to thereby further increase the stirring ability.

In the first and second means, all of the plurality of stirring vessels are preferably constructed so as to impart resistance opposite (upstream direction of downstream direction) to the flow in the forward direction (downstream direction or upstream direction) of the molten glass by the stirring blade accommodated in the stirring vessel.

Thus, the molten glass is stirred with the stirring blade in a manner of preventing the flow of the molten glass. Therefore, as compared with the case where the stirring direction is opposite to the above direction, time for the molten glass to receive the stirring action with the stirring blade is prolonged to thereby obtain a sufficient stirring performance.

In the first and second means, a temperature of the molten glass which flows through all of the insides of the plurality of stirring vessels is preferably 1,350 to 1,550° C.

More specifically, the temperature of the molten glass is excessively low, the viscosity becomes inappropriately high, which causes a fatal defect that the stirring blade is chipped due to resistance of the molten glass, and the chipped foreign matter is mixed in the molten glass. In contrast, when the temperature of the molten glass is excessively high, early deterioration and decrease in durability of the stirring blade arise. In view of the above-described matters, it is preferred that the temperature of the molten glass which flows through the inside of all of the plurality of stirring vessels is in the above-mentioned numerical range. More preferred results can be obtained when the lower limit is 1,400° C. and the upper limit is 1,500° C.

Further, a viscosity of the molten glass which flows through all of the insides of the plurality of stirring vessels is preferably 300 to 7,000 poise.

More specifically, when the temperature of the molten glass is excessively low, the temperature becomes inappropriately high, early deterioration and decrease in durability of the stirring blade arise. In contrast, when the temperature of the molten glass is excessively high, a fatal defect occurs that the stirring blade is chipped due to resistance of the molten glass, and the chipped foreign matter is mixed in the molten glass. In view of the above-described matters, it is preferred that the viscosity of the molten glass which flows through the inside of all of the plurality of stirring vessels is in the above-mentioned numerical range. More preferred results can be obtained when the lower limit is 700 poise and the upper limit is 4,000 poise.

According to the above-described first and second means, when a sheet glass produced with the forming device is used without polishing both the front and rear sides, the effects of the present invention is further enjoyable.

More specifically, when a sheet glass is used in an unpolished state, the homogeneity of glass directly determines the surface quality of glass. Therefore, when the apparatus of the present invention is used, the previously-described heterogeneous phase on the front surface portion and the heterogeneous phase on the bottom portion in a high viscosity molten glass, for example, are subjected to stirring action by the plurality of stirring vessels (especially a homogenization vessel) to be homogenized. Therefore, quality degradation in which defects are formed on the unpolished front and rear surfaces of a sheet glass due to these heterogeneous phases, especially the development of a defective, can be effectively suppressed.

A third means to solve the first object is a process for production of a glass formed article including the steps of melting a high viscosity glass having a property that a temperature equivalent to a viscosity of 1,000 poise is 1,350° C. or higher in a melting furnace, stirring the molten glass by causing the molten glass to flow into and pass through a stirring vessel placement portion which is provided on the way of a supply passage and in which a plurality of stirring vessels for conducting homogenization are disposed adjacent to each other at an upstream side and at a downstream side, when the molten glass flows through the supply passage which leads from the melting furnace to a forming device at a downstream side of the melting furnace, and forming the molten glass, which has been stirred and supplied to the forming device, into a glass formed article.

Since the constitutional elements of the production process according to the third means and various matters concerning the elements are substantially the same as the matters already described about the first means, the description thereof is omitted here for convenience.

A fourth means to solve the second object is a process for production of a glass formed article including the steps of melting a high viscosity glass having a property that a temperature equivalent to a viscosity of 1,000 poise is 1,350° C. or higher in a melting furnace; stirring the molten glass by causing the molten glass to flow into and pass through a stirring vessel placement portion which is provided on the way of a supply passage and in which a plurality of stirring vessels, which are provided separately and independently, are disposed adjacent to each other at an upstream side and at a downstream side, when the molten glass flows through the supply passage which leads from the melting furnace to a forming device at a downstream side of the melting furnace, and forming the molten glass, which has been stirred and supplied to the forming device, into a glass formed article.

Since the constitutional elements of the production process according to the fourth means and various matters concerning the elements are substantially the same as the matters already described according to the second means, the description thereof is omitted here for convenience.

Also when the production processes according to the third and fourth means are carried out, in order to obtain the same respective action effects as obtained in the already-described apparatus, it is preferred that the plurality of stirring vessels be structured so that the molten glass immediately after flowing into the stirring vessel from an inflow opening of the stirring vessel is brought into contact with the stirring blade accommodated therein. It is more preferred that a part of the molten glass immediately after flowing into the stirring vessel from the inflow opening of the stirring vessel be brought into contact with the stirring blade and a remaining portion of the molten glass flow into a portion opposite to the forward direction of the flow of the molten glass rather than the stirring blade. Moreover, it is preferred that the plurality of stirring vessels be constructed so as to impart resistance opposite to the forward direction of the flow of the molten glass by the stirring blade accommodated in the stirring vessel. The temperature of the molten glass which flows through the inside of all the plurality of stirring vessels is preferably 1,350 to 1,550° C. (lower limit: 1,400° C. and upper limit: 1,500° C.) and the viscosity is preferably 300 to 7,000 poise (lower limit: 700 poise and upper limit: 4,000 poise). Moreover, it is preferred to form a sheet glass in forming process by an overflow down-draw process so that the obtained glass can be used in an unpolished state.

A fifth means to solve the third object is a molten glass supply apparatus including a melting furnace serving as a supply source of a molten glass, and a supply passage for supplying a molten glass which has flowed out of the melting furnace to a forming device, a plurality of stirring vessels being disposed adjacent to each other in an upstream direction and in an downstream direction on the way of the supply passage, among at least two adjacent stirring vessels, a stirring vessel at an upstream side has an inflow opening at one of an upper portion and a lower portion and an outflow opening at another side, an inflow opening and an outflow opening of a stirring vessel at a downstream side being formed so that upper and lower portions are the same as in the stirring vessel at the upstream side, and an outflow opening of the stirring vessel at the upstream side being connected to an inflow opening of the stirring vessel at the downstream side whose upper and lower portions are upside-down to the outflow opening through a communicating passage.

In this case, the above-mentioned “a plurality of stirring vessels are disposed adjacent to each other in the upstream and downstream directions” as used herein should be understood as that there is no vessel between the adjacent stirring vessels. Moreover, the above-mentioned “connected through a communicating passage” as used herein should be understood as that it is preferred that the outflow opening of the stirring vessel at the upstream side and the inflow opening of the stirring vessel at the downstream side be connected only by the communicating passage which mainly functions as a channel. It should be noted that, with respect to the communicating passage, providing a baffle plate on the way of the communicating passage is not excluded. Moreover, it is preferred for the passage area of the communicating passage to be smaller than the passage area of the stirring vessel. The above-described matters similarly apply to the “a plurality of stirring vessels are disposed adjacent to each other in the upstream and downstream directions” and “connected through a communicating passage” which will be described later and the structure of a communicating passage which will be described later is also the same as described above.

According to the fifth means, when a molten glass flows through at least two adjacent stirring vessels among the plurality of stirring vessels disposed adjacent to each other in the upstream and downstream directions on the way of the supply passage, as a first circulation route, the molten glass flows into the stirring vessel at the upstream side through an inflow opening formed in the upper portion of the stirring vessel, flows downward through the inside, and flows out to the communicating passage from an outflow opening formed in the lower portion of the stirring vessel at the upstream side. Further, the molten glass passes through the communicating passage, flow into the stirring vessel at the downstream side through an inflow opening formed in the upper portion of the stirring vessel, flows downward through the inside, and flows out of an outflow opening formed in the lower portion of the stirring vessel at the downstream side. More specifically, the molten glass which flows along the first circulation route flows through the stirring vessel at the upstream side from the upward position to the downward position, flows through the communicating passage from a position corresponding to the downward position to a position corresponding to the upward position, and then flows through the stirring vessel at the downstream from the upward position to the downward position. In contrast, as a second circulation route, a molten glass flows into the stirring vessel at the upstream side through an inflow opening formed in the lower portion of the stirring vessel, flows upward through the inside, and flows out to the communicating passage from an outflow opening formed in the upper portion of the stirring vessel at the upstream side. Further, the molten glass passes through the communicating passage, flow into the stirring vessel at the downstream side through an inflow opening formed in the lower portion of the stirring vessel, flows upward through the inside, and flows out of an outflow opening formed in the upper portion of the stirring vessel at the downstream side. More specifically, the molten glass which flows along the second circulation route flows through the stirring vessel at the upstream side from the downward position to the upward position, flows through the communicating passage from a position corresponding to the upward position to a position corresponding to the downward position, and then flows through the stirring vessel at the downstream side from the downward position to the upward position. According to the simulation (model experiment) conducted by the inventors of the present invention for a high viscosity glass about the structure in which two stirring vessels, which are provided separately and independently, are communicated with each other so that a molten glass may flow along the above-mentioned circulation channel (especially the first circulation route) which will be described later, results have been obtained that the molten glass can appropriately flow in a homogeneous state throughout the molten glass while eliminating the previously-described both the heterogeneous phase on the surface portion and the heterogeneous phase on the bottom portion. Thus, in the results of the model experiment in which two stirring vessels which are provided separately and independently, the heterogeneous phase is appropriately homogenized throughout the molten glass. Therefore, even in the case where the stirring vessels are not provided independently and exist as a portion of a vessel which is larger than the stirring vessel, it can be assumed that the molten glass can be homogenized to a considerable degree and that a low viscosity molten glass can be homogenized similarly. Further, also in the structure in which two stirring vessels are communicated so that a molten glass may flow along the above-mentioned second circulation route (both the cases where the stirring vessels are provided independently and where the stirring vessels are not provided independently), since the fundamental structure of the second circulation route is the same as in the case of the above-mentioned first circulation route, it can be assumed that the molten glass is sufficiently homogenized therethroughout.

In this case, it is preferred to connect the outflow opening formed in the lower portion of the stirring vessel at the upstream side with the inflow opening formed in the upper portion of the stirring vessel at the downstream side through the communicating passage.

Thus, the stirring vessel at the upstream side and the stirring vessel at the downstream side are communicated so that a molten glass may flow along the first circulation route, which results in that a preferred homogenization action following to the simulation experiment conducted by the inventors of the present invention is achieved.

According to the above-described fifth means, it is preferred that all of the plurality of stirring vessels be provided separately and independently. The above-mentioned “provided separately and independently” as used herein should be understood as that portions each which conduct a stirring action do not exist separately as a part of a vessel, and the respective vessels are structured so that all of the vessels each conduct a stirring action.

Thus, a plurality of stirring vessels, which are provided separately and independently, are disposed adjacent to each other in the upstream and downstream directions on the way of the supply passage. Therefore, each stirring vessel can be independently dealt with, and thus maintenance inspection, repair, or exchanging, etc., can be conducted easily and simply. Therefore, the convenience of handling of each stirring vessel improves.

Moreover, according to the above-described fifth means, it is preferred that all of the plurality of stirring vessels be structured so that homogenization action may be conducted. The above-mentioned “homogenization action” as used herein should be understood as an action by which a heterogeneous phase is eliminated or decreased.

Thus, it is not some stirring vessels that conduct an action of converting occluded gas to a foam, an action of pushing downward a molten glass which intends to rise, a defoaming action, or a temperature control action, and all of the stirring vessels conduct homogenization. Therefore, the above-mentioned molten glass is homogenized very appropriately.

Further, according to the fifth means described above, it is preferred that, in all of the plurality of stirring vessels, the inner peripheral portion be formed of a cylindrical peripheral wall portion and a bottom wall part which form a cylindrical surface and the outer peripheral end of the stirring blade accommodated in the stirring vessels be close to the inner peripheral portion. The above-mentioned “close to” as used herein should be understood as that a gap between the outer peripheral end of the stirring blade and the inner peripheral surface of the peripheral wall portion is 20 mm or less, preferably 10 mm or less.

Thus, since the inner peripheral surface of the peripheral wall portion forms a cylindrical surface and the peripheral end of the stirring blade is close to the inner peripheral surface of the stirring vessel, the moving track of the stirring blade can be made to exist almost throughout the passage cross section of the stirring vessel, and the stirring effect can be sufficiently given also to the molten glass near the inner peripheral surface.

Then, according to the fifth means described above, a sheet glass produced with the forming device can further enjoy the effects of the present invention when used in a state where both the front and rear surfaces are not polished.

More specifically, when the sheet glass is used in an unpolished state, the homogeneity of glass directly determines the surface quality of the glass. Therefore, when the apparatus of the present invention is used, the heterogeneous phase in the molten glass is subjected to stirring action by the plurality of stirring vessels to be homogenized. Therefore, quality degradation in which defects are formed on both the unpolished front and rear surfaces of the sheet glass due to the heterogeneous phases, especially the development of a defective, can be effectively suppressed.

A sixth means to solve the third object is a process for production of a glass formed article including the steps of melting a glass raw material in a melting furnace, stirring the molten glass by a stirring vessel on the way of a supply passage which leads from the melting furnace to a forming device at a downstream side of the melting furnace, and forming the molten glass, which has been stirred and supplied to the forming device, into a glass formed article, in which the molten glass is stirred by causing the molten glass to flow into and pass through a stirring vessel placement position on the way of a supply passage, in the stirring vessel placement position, a plurality of stirring vessels being disposed adjacent to each other in an upstream direction and in a downstream direction, among at least two adjacent stirring vessels, a stirring vessel at an upstream side having an inflow opening at one of an upper portion and a lower portion and an outflow opening at the other side, an inflow opening and an outflow opening of a stirring vessel at a downstream side being formed so that upper and lower portions are the same as in the stirring vessel at the upstream side, and the outflow opening of the stirring vessel at the upstream side being connected to the inflow opening of the stirring vessel at the downstream side in which upper and lower portions are upside-down to the outflow opening through a communicating passage.

Since the constitutional elements of the production process according to the sixth means and various matters concerning the elements are substantially the same as the matters already described about the fifth means, the description thereof is omitted here for convenience.

In this case, in the stirring vessel placement portion on the way of the supply passage, it is preferred to connect the outflow opening formed in the lower portion of the stirring vessel at the upstream side with the inflow opening formed in the upper portion of the stirring vessel at the downstream side through the communicating passage.

Thus, the stirring vessel at the upstream side and the stirring vessel at the downstream side are communicated so that a molten glass may flow along the same circulation route as that of the simulation conducted by the inventors of the present invention. Therefore, a preferred homogenization action following to the simulation experiment conducted by the inventors is performed in the stirring process.

Also when carrying out the production process according to the sixth means described above, in order to the same respective action effects as those in the matters about the previously-described device according to the fifth means, it is preferred that all of the plurality of stirring vessels be provided separately and independently and that all of the plurality of stirring vessels are structured to conduct homogenization. Further, it is preferred that, in all of the plurality of stirring vessels, the inner peripheral portion be formed of a cylindrical peripheral wall portion and a bottom wall portion which form a cylindrical surface, the outer peripheral end of the stirring blade accommodated in the stirring vessels be close to the inner peripheral surface of the stirring vessel, and both the front and rear surfaces of a sheet glass formed with the forming device be unpolished.

According to the seventh means to solve the fourth object described above, in a molten glass supply apparatus equipped with a melting furnace serving as a supply source of a molten glass and a supply passage for supplying the molten glass which has flowed out of the melting furnace to a forming device, a plurality of stirring vessels provided, which are provided separately and independently, are disposed adjacent to each other in the upstream and downstream directions on the way of the supply passage, among at least two adjacent stirring vessels, an inflow opening is formed at either the upper portion or the lower portion of the stirring vessel at the upstream side and an outflow opening is formed at the other portion, the inflow opening and the outflow opening of the stirring vessel at the downstream side are formed so that the upper and lower portions are upside-down to the stirring vessel at the upstream side, and the outflow opening of the stirring vessel at the upstream side is connected to the inflow opening of the stirring vessel at the downstream side, whose upper and lower portions are the same as in the outflow opening, through the communicating passage.

In this case, the above-mentioned “a plurality of stirring vessels which are provided separately and independently” as used herein should be understood as that a portion which conducts a stirring action does not exist as a part of a vessel and all of the vessels are structured to conduct a stirring action. Moreover, the above-mentioned “a plurality of stirring vessels are disposed adjacent to each other in the upstream and downstream directions” as used herein should be understood as that there is no vessel between the adjacent stirring vessels. Moreover, the above-mentioned “connected through a communicating passage” as used herein should be understood as that it is preferred that the outflow opening of the stirring vessel at the upstream side and the inflow opening of the stirring vessel at the downstream side are connected only by the communicating passage which mainly functions as a channel. It should be noted that, with respect to the communicating passage, providing a baffle plate on the way of the communicating passage is not excluded. Moreover, it is preferred for the passage area of the communicating passage to be smaller than the passage area of the stirring vessel. The same applies to “a plurality of stirring vessels which are provided separately and independently”, “a plurality of stirring vessels are disposed adjacent to each other in the upstream and downstream directions”, and “connected through a communicating passage” which will be described later, and the structure of the communicating passage which will be described later is the same as the above.

According to the seventh means, since the plurality of stirring vessels are provided separately and independently on the way of the supply passage, each stirring vessel can be independently dealt with. Thus, maintenance inspection, repair, or exchanging, etc., can be conducted easily and simply. Therefore, the convenience of handling of each stirring vessel improves. Moreover, when a molten glass flows through at least two adjacent stirring vessels among the plurality of stirring vessels disposed adjacent to each other in the upstream and downstream directions on the way of the supply passage, as a first circulation route, the molten glass flows into the stirring vessel at the upstream side through an inflow opening formed in the upper portion of the stirring vessel, flows downward through the inside, and flows out to the communicating passage from an outflow opening formed in the lower portion of the stirring vessel at the upstream side. Further, the molten glass passes through the communicating passage, flow into the stirring vessel at the downstream side through an inflow opening formed in the lower portion of the stirring vessel, flows upward through the inside, and flows out of an outflow opening formed in the upper portion of the stirring vessel at the downstream side. More specifically, the molten glass which flows along the first circulation route flows through the stirring vessel at the upstream side from the upward position to the downward position, flows through the communicating while the downward position is being maintained, and then flows through the stirring vessel at the downstream from the downward position to the upward position. In contrast, as a second circulation route, a molten glass flows into the stirring vessel at the upstream side through an inflow opening formed in the lower portion of the stirring vessel, flows upward through the inside, and flows out to the communicating passage from an outflow opening formed in the upper portion of the stirring vessel at the upstream side. Further, the molten glass passes through the communicating passage, flow into the stirring vessel at the downstream side through an inflow opening formed in the upper portion of the stirring vessel, flows downward through the inside, and flows out of an outflow opening formed in the lower portion of the stirring vessel at the downstream side. More specifically, the molten glass which flows along the second circulation route flows through the stirring vessel at the upstream side from the downward position to the upward position, flows through the communicating passage while the upward position is being maintained, and then flows through the stirring vessel at the downstream side from the upward position to the downward position. Here, according to the simulation experiment (model experiment), which will be described later, conducted by the inventors of the present invention for a high viscosity glass about the structure in which two stirring vessels, which are provided separately and independently, are communicated with each other so that a molten glass may flow along the above-mentioned circulation channel (especially the first circulation route), experiment results have been obtained that, in the case where although especially the previously-described heterogeneous phase on the surface portion becomes a problem, the heterogeneous phase on the bottom portion hardly becomes a problem (e.g., in the case where a heterogeneous phase becoming a problem is not formed on the bottom portion or, even when a heterogeneous phase becoming a problem is formed on the bottom portion, a molten glass whose amount becomes a problem in a stirring vessel does not flow), the heterogeneous phase on the surface portion can be eliminated to homogenize the molten glass. Based on the results, the homogenization effect of the two stirring vessels, which are provided separately and independently, for a high viscosity molten glass is proved and also it can be assumed that a low viscosity molten glass can be homogenized similarly. Further, also in the structure in which two stirring vessels are communicated with each other so that the molten glass may flow along the above-mentioned second circulation route, since the fundamental structure of the second circulation route is the same as that of the above-mentioned first circulation route, it can be assumed that the molten glass, especially the front surface portion thereof, is sufficiently homogenized. Therefore, such a communicating structure is employed for the supply passage in which especially the heterogeneous phase on the front surface portion becomes a problem, it is expectable to acquire an outstanding effect of homogenizing a molten glass.

In this case, it is preferred to connect the outflow opening formed in the lower portion of the stirring vessel at the upstream side with the inflow opening formed in the upper portion of the stirring vessel at the downstream side through the communicating passage.

Thus, the stirring vessel at the upstream side and the stirring vessel at the downstream side are communicated so that a molten glass may flow along the first circulation route, which results in that a preferred homogenization action following to the simulation experiment conducted by the inventors of the present invention is achieved.

Moreover, according to the above-described seventh means, it is preferred that all of the plurality of stirring vessels be structured so that homogenization action may be conducted. The above-mentioned “homogenization action” as used herein should be understood as an action by which a heterogeneous phase is eliminated or decreased.

Thus, it is not some stirring vessels that conduct an action of converting occluded gas to a foam, an action of pushing downward a molten glass, which intends to rise, a defoaming action, or a temperature control action, and all of the stirring vessels conduct homogenization. Therefore, the above-mentioned molten glass is homogenized very appropriately.

Further, according to the seventh means described above, it is preferred that, in all of the plurality of stirring vessels, the inner peripheral portion be formed of a cylindrical peripheral wall portion and a bottom wall part which form a cylindrical surface and the outer peripheral end of the stirring blade accommodated in the stirring vessels be close to the inner peripheral portion. The above-mentioned “close to” as used herein should be understood as that a gap between the outer peripheral end of the stirring blade and the inner peripheral surface of the peripheral wall portion is 20 mm or lower, preferably 10 mm or lower.

Thus, since the inner peripheral surface of the peripheral wall portion forms a cylindrical surface and the peripheral end of the stirring blade is close to the inner peripheral surface of the stirring vessel, the moving track of the stirring blade can be made to exist almost throughout the passage cross section of the stirring vessel, and the stirring effect can be sufficiently given also to the molten glass near the inner peripheral surface.

Then, according to the seventh means described above, a sheet glass produced with the forming device can further enjoy the effects of the present invention when used in a state where both the front and rear surfaces are not polished.

Further, when the sheet glass is used in an unpolished state, the homogeneity of glass directly determines the surface quality of the glass. Therefore, when the apparatus of the present invention is used, the heterogeneous phase in the molten glass is subjected to stirring action by the plurality of stirring vessels to be homogenized. Therefore, quality degradation in which defects are formed on both the unpolished front and rear surfaces of the sheet glass due to the heterogeneous phases, especially the development of a defective, can be effectively suppressed.

An eight means to solve the fourth object is a process for production of a glass formed article including the steps of melting a glass raw material in a melting furnace, stirring the molten glass by a stirring vessel on the way of a supply passage which leads from the melting furnace to a forming device at a downstream side of the melting furnace, and forming the molten glass, which has been stirred and supplied to the forming device, into a glass formed article, in which the molten glass is stirred by causing the molten glass to flow into and pass through a stirring vessel placement position on the way of a supply passage, in the stirring vessel placement position, a plurality of stirring vessels, which are provided separately and independently, being disposed adjacent to each other in an upstream direction and in a downstream direction, among at least two adjacent stirring vessels, a stirring vessel at an upstream side having an inflow opening at one of an upper portion and a lower portion and an outflow opening at the other side, an inflow opening and an outflow opening of a stirring vessel at a downstream side being formed so that the upper and lower portions are upside-down to the stirring vessel at the upstream side, and the outflow opening of the stirring vessel at the upstream side being connected to the inflow opening of the stirring vessel at the downstream side in which upper and lower portions are the same as in the outflow opening through a communicating passage.

Since the constitutional elements of the production process according to the eighth means and various matters concerning the elements are substantially the same as the matters already described about the seventh means, the description thereof is omitted here for convenience.

In this case, in the stirring vessel placement portion on the way of the supply passage, it is preferred to connect the outflow opening formed in the lower portion of the stirring vessel at the upstream side with the inflow opening formed in the lower portion of the stirring vessel at the downstream side through the communicating passage.

Thus, the stirring vessel at the upstream side and the stirring vessel at the downstream side are communicated so that a molten glass may flow along the same circulation route as that of the simulation conducted by the inventors of the present invention. Therefore, a preferred homogenization action following to the simulation experiment conducted by the inventors is performed in the stirring process.

Also when carrying out the production process according to the eighth means described above, in order to the same respective action effects as those in the matters about the previously-described device according to the seventh means, it is preferred that all of the plurality of stirring vessels be provided separately and independently and that all of the plurality of stirring vessels are structured to conduct homogenization. Further, it is preferred that, in all of the plurality of stirring vessels, the inner peripheral portion be formed of a cylindrical peripheral wall portion and a bottom wall part which form a cylindrical surface, the outer peripheral end of the stirring blade accommodated in the stirring vessel be close to the inner peripheral surface of the stirring vessel, and both the front and rear surfaces of a sheet glass formed with the forming device be unpolished.

According to the above-described fifth, sixth, seventh, and eighth means, a molten glass has a high viscosity property that a temperature equivalent to a viscosity of 1,000 poise is 1,350° C. or higher. When the molten glass is a glass having a high viscosity property that a temperature equivalent to a viscosity of 1,000 poise is 1,420° C. or higher, such a glass is advantageous in that the glass can be distinguished from a low viscosity glass more clearly. As such a high viscosity glass mentioned above, alkali free glass (glass containing an alkali component in a proportion of 0.1 mass % or lower, particularly 0.05 mass % or lower) can be mentioned as an example. To be specific, based on mass %, alkali free glass containing 40 to 70% SiO₂, 6 to 25% Al₂O₃, 5 to 20% B₂O₃, 0 to 10% MgO, 0 to 15% CaO, 0 to 30% BaO, 0 to 10% SrO, 0 to 10% ZnO, and 0 to 5% fining agents is mentioned. More preferably, alkali free glass containing 55 to 70% SiO₂, 10 to 20% Al₂O₃, 5 to 15% B₂O₃, 0 to 5% MgO, 0 to 10% CaO, 0 to 15% BaO, 0 to 10% SrO, 0 to 5% ZnO, and 0 to 3% fining agents is mentioned.

### EFFECT OF THE INVENTION

As described above, according to the molten glass supply apparatus (first means) of the present invention, since the stirring vessels are disposed adjacent to each other in the upstream and downstream directions at the supply passage only for a high viscosity glass, even if the flow amount of the molten glass which flows through the supply passage increases, the molten glass passes the plurality of homogenization vessel to thereby increase the stirring ability, especially the homogenizing ability. Therefore, a heterogeneous phase which is formed due to a glass having a high viscosity is appropriately eliminated to thereby sufficiently homogenize the molten glass. Further, when the plurality of homogenization vessels exist as described above, a total stirring ability (homogenizing ability) can be sufficiently increased without increasing the rotation number of the stirring blade per homogenization vessel. Therefore, a defect that the stirring blade is chipped due to resistance of a high viscosity molten glass, and the chipped foreign matter (platinum or the like) is mixed in the molten glass, which causes a fatal defect in a glass formed article, is effectively suppressed.

Moreover, according to the molten glass supply apparatus (second means) of the present invention, since a plurality of stirring vessels, which are provided separately and independently, are provided on the way of the supply passage only for a high viscosity glass, each stirring vessel can be independently dealt with, thereby easily and simply conducting maintenance inspection, repair, or exchanging, etc. Further, also when controlling the temperature of the stirring portion so as to appropriately control resistance which acts on the stirring blade from the molten glass, the stirring portion in each vessel is less susceptible to influences of other portions, and the temperature control, especially the viscosity control, of the molten glass which flows through the stirring portion (stirring vessel) can be readily and properly conducted.

In contrast, the production process (third means) of a glass formed article of the present invention exhibits substantially the same effects as in the above-described molten glass supply apparatus (first means).

In contrast, the production process (fourth means) of a glass formed article of the present invention exhibits substantially the same effects as in the above-described molten glass supply apparatus (second means).

Further, according to the molten glass supply apparatus (fifth means) of the present invention, after a molten glass which has flowed through the stirring vessel at the upstream side from the upward position to the downward position flows through the communicating passage from a position corresponding to the downward position to a position corresponding to the upward position, the molten glass flows through the stirring vessel at the downstream side from the upward position to the downward position or after a molten glass which has flowed through the stirring vessel at the upstream side from the downward position to the upward position flows through the communicating passage from a position corresponding to the upward position to a position corresponding to the downward position, the molten glass flows through the stirring vessel at the downstream side from the downward position to the upward position. Therefore, even when heterogeneous phases exist on the front surface portion and the bottom portion, the molten glass can be homogenized therethroughout by eliminating the two kinds of heterogeneous phases.

The production process (sixth means) of a glass formed article of the present invention exhibits substantially the same effects as in the above-described molten glass supply apparatus (fifth means).

According to the molten glass supply apparatus (seventh means) of the present invention, since a plurality of stirring vessels, which are provided separately and independently, are provided on the way of the supply passage, each stirring vessel can be independently dealt with, thereby easily and simply conducting maintenance inspection, repair, or exchanging, etc. Moreover, after a molten glass which has flowed through the stirring vessel at the upstream side from the upward position to the downward position flows through the communicating passage while the lower position is being maintained, the molten glass flows through the stirring vessel at the downstream side from the downward position to the upward position or after a molten glass which has flowed through the stirring vessel at the upstream side from the downward position to the upward position flows through the communicating passage while the upper position is being maintained, the molten glass flows through the stirring vessel at the downstream side from the upward position to the downward position. Therefore, when especially the heterogeneous phase at the front surface portion of the molten glass becomes a problem, the molten glass can be appropriately homogenized by eliminating the heterogeneous phase.

The production process (eighth means) of the glass formed article of the present invention exhibits substantially the same effects as in the above-described molten glass supply apparatus (seventh means).

### BRIEF DESCRIPTION OF THE DRAWINGS

FIG. 1 is a front view illustrating the outline structure of a molten glass supply apparatus according to First Embodiment of the present invention.

FIG. 2 is a vertical cross sectional front view illustrating a component of a first stirring vessel which is a component of the molten glass supply apparatus according to First Embodiment.

FIG. 3 is an outline vertical cross sectional front view illustrating that a molten glass flows through the first stirring vessel and a second stirring vessel which are components of the molten glass supply apparatus according to First Embodiment.

FIG. 4 is a front view illustrating the outline structure of an essential part of a molten glass supply apparatus according to Second Embodiment of the present invention.

FIG. 5 is a front view illustrating the outline structure of an essential part of a molten glass supply apparatus according to Third Embodiment of the present invention.

FIG. 6 is a front view illustrating the outline structure of an essential part of a molten glass supply apparatus according to Fourth Embodiment of the present invention.

FIG. 7 is a vertical cross sectional front view illustrating an essential part of a second stirring vessel which is a component of the molten glass supply apparatus according to Fourth Embodiment.

FIG. 8 is an outline vertical cross sectional front view illustrating that a molten glass flows through the inside of the first stirring vessel and the second stirring vessel which are components of the molten glass supply apparatus according to Fourth Embodiment.

FIG. 9 is a front view illustrating the outline structure of an essential part of a molten glass supply apparatus according to Fifth Embodiment of the present invention.

FIG. 10 is a front view illustrating the outline structure of an essential part of a molten glass supply apparatus according to Sixth Embodiment of the present invention.

FIG. 11 is a front view illustrating the outline structure of an essential part of a molten glass supply apparatus according to Seventh Embodiment of the present invention.

FIG. 12 is a front view illustrating the outline structure of an essential part of a molten glass supply apparatus according to Eighth Embodiment of the present invention.

FIG. 13 is a graph illustrating actions of the molten glass supply apparatuses according to First to Eighth Embodiments of the present invention.

FIG. 14 is a graph illustrating actions of the molten glass supply apparatuses according to First to Eighth Embodiments of the present invention.

### DESCRIPTION OF SYMBOLS

1 molten glass supply apparatus
2 melting furnace
3 forming device
4 supply passage
K1 first stirring vessel
K2 second stirring vessel
K3 third stirring vessel
K4 fourth stirring vessel
M1 first inflow opening
M2 second inflow opening
M3 third inflow opening
M4 fourth inflow opening
S1 stirring blade (first stirring means)
S2 stirring blade (second stirring means)
S3 stirring blade (third stirring means)
S4 stirring blade (fourth stirring means)

### BEST MODE FOR CARRYING OUT THE INVENTION

Hereinafter, the present invention will be described with reference to the attached drawings.

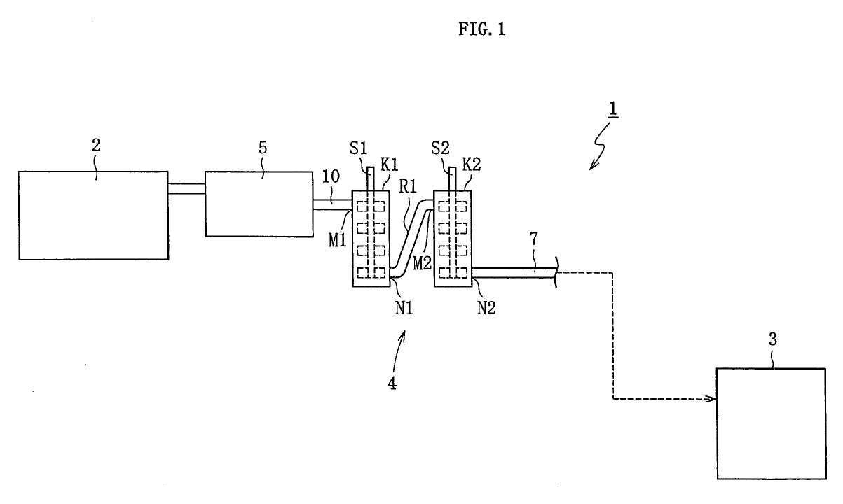

First, the outline structure of a molten glass supply apparatus according to First Embodiment of the present invention will be described with reference to FIG. 1. As illustrated in FIG. 1, a molten glass supply apparatus 1 has a melting furnace 2 which is provided at the upstream end and melts a glass raw material, and supplies a high viscosity molten glass (having a property that a temperature equivalent to a viscosity of 1,000 poise is 1,350° C. or higher) which has flowed out of the melting furnace 2 to a forming body of a forming device 3 for forming a sheet glass by an overflow down-draw process through a supply passage 4. To be specific, as a high viscosity glass to be supplied here, alkali free glass can be, for example, used which has a composition of, based on mass %, 60% SiO₂, 15% Al₂O₃, 10% B₂O₃, 5% CaO, 5% BaO, and 5% SrO and whose temperature equivalent to a viscosity of 1,000 poise is about 1,450° C. A fining vessel 5 which leads to the direct downstream side of the melting furnace 2 of the upstream end is provided on the above-mentioned supply passage 4. At the direct downstream side of the fining vessel 5, a first stirring vessel K1 at the upstream side and a second stirring vessel K2 at the downstream side, which are provided separately and independently, are disposed adjacent to each other in the upstream and downstream directions. Both the stirring vessels K1 and K2 conduct homogenization. Further, the temperature of a molten glass which flows through the inside of both the stirring vessels K1 and K2 is 1,350 to 1,550° C. (preferably 1,400 to 1,500° C.) and the viscosity thereof is controlled to be 300 to 7,000 poise (preferably 700 to 4,000 poise). The molten glass is supplied to the forming body of the forming device 3 from the downstream side of the second stirring vessel K2 through a cooling pipe 7, a pot, a minor diameter tube, and a major diameter tube, which are not shown in FIG. 1, and is formed into a sheet shape. Then, the sheet glass formed with the forming device 3 is formed into a product in a state where both the front and rear surfaces are not polished.

In the first and second stirring vessels K1 and K2, first and second stirring means S1 and S2 each having a single stirrer are accommodated therein. The inner peripheral surfaces of the vessels K1 and K2 are formed into a cylindrical surface, respectively, throughout the entire area of the upward and downward directions and the inner peripheral surfaces of the stirring vessels K1 and K2 and the outer peripheral ends of the first and second stirring means (each stirring blade) S1 and S2 are close to each other, respectively. In both the first and second stirring vessels K1 and K2, a cylindrical peripheral wall and a bottom wall are made of platinum or a platinum alloy, and the two vessels K1 and K2 are the same or substantially the same in the dimension, shape, and internal structure. A fining passage 10 leading to the downstream side from the fining vessel 5 is connected to the upper portion (top end of the peripheral wall) of a first stirring vessel K1. The lower portion (bottom end of the peripheral wall) of the first stirring vessel K1 and the upper portion (top end of the peripheral wall) of the second stirring vessel K2 are connected through a first communicating passage R1. The lower portion (bottom end of the peripheral wall) of the second stirring vessel K2 is connected to the cooling pipe 7 (cooling passage) which leads to the pot. Therefore, the molten glass which has flowed into the first stirring vessel K1 through a first inflow opening M1 formed in the upper portion of the first stirring vessel K1 from the fining passage 10 flows downward through the inside of the first stirring vessel K1, and then flows out to the first communicating passage R1 through a first outflow opening N1 formed in the lower portion of the first stirring vessel K1. Then, the molten glass flows obliquely upward through the first communicating passage R1 to pass therethrough, and then flows into the second stirring vessel from the first communicating passage R1 through a second inflow opening M2 formed in the upper portion of the second stirring vessel K2. Then, the molten glass flows downward through the inside of the second stirring vessel K2, and then flows out to the cooling passage 7 through a second outflow opening N2 formed in the lower portion of the second stirring vessel K2. Each of the above-mentioned inflow openings is formed at the upstream side portion of the peripheral wall of each stirring vessel and each outflow opening is formed at the downstream side portion of the peripheral wall of each stirring vessel. The passage area of each inflow opening and each outflow opening is controlled to be smaller than the passage area of the inside of each stirring vessel (hereinafter, the same applies to each inflow opening and each outflow opening in the following embodiments).

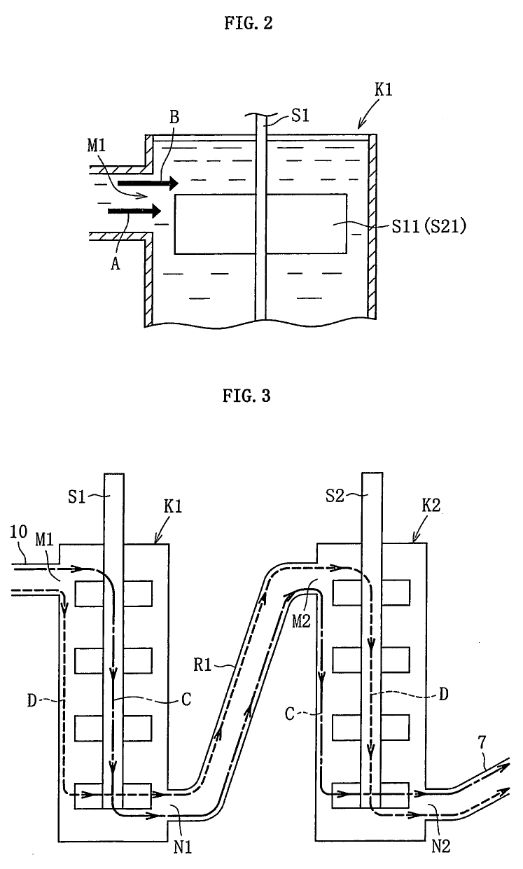

In this case, as illustrated in FIG. 2, the respective means are positioned so that immediately after the molten glass flows into the first stirring vessel from the first inflow opening M1 of the first stirring vessel K1, the molten glass is partially brought into contact with a stirring blade S11 at the top stage of the first stirring means S1 through the route indicated by Arrow A, and simultaneously, the remaining portion flows into the upper portion relative to the stirring blade S11 at the top stage through the route indicated by Arrow B. Moreover, the respective means are positioned so that also the molten glass which flows into the second stirring vessel K2 from the second inflow opening M2 of the second stirring vessel K2 is partially brought into contact with the stirring blade S21 at the top stage of the second stirring means S2, and simultaneously the remaining portion flows into the upper portion relative to the stirring blade S21 of the top stage. With respect to the molten glass which flow into the first stirring vessel K1 and the second stirring vessel K2 to flow downward through the inside, both the first stirring means S1 and the second stirring means S2 are constructed so as to impart resistance directing upward, i.e., resistance opposite to the flow of the molten glass.

In order to produce a sheet glass as a glass formed article using the molten glass supply apparatus 1 equipped with the above-described structure, conducted are a melting step for melting a high viscosity glass in the melting furnace 2, a stirring step for causing the molten glass to flow into and pass through the first and second stirring vessels K1 and K2 for stirring, which are provided separately and independently and conducts homogenization, when the molten glass flows from the melting furnace 2 through a supply passage 4 which leads to a forming device 3 at the downstream side, and a forming step for supplying the molten glass, which has been stirred in the stirring step, to the forming device 3 to form a sheet glass.

Next, the above-described stirring process in First Embodiment will be described in detail.

The molten glass which has flowed out of the melting furnace 2 and flowed into the fining vessel 5 (see FIG. 1) first flows into the first stirring vessel K1 through the first inflow opening M1 from the fining passage 10. Then, the molten glass flows downward through the inside of the first stirring vessel K1 while being stirred by the first stirring means S1 which is rotating, and then flows out of the first outflow opening N1 to flow obliquely upward through the first communicating passage R1. Then, the molten glass flows into the second stirring vessel K2 through the second inflow opening M2 from the first communicating passage R1, and flows downward through the inside of the second stirring vessel K2 while being stirred by the second stirring means S2 which is rotating. Then, the molten glass flows out of the second outflow opening N2 to reach the cooling passage 7.

FIG. 3 is a view schematically illustrating the results of the simulation experiment (model experiment) about the state of the molten glass which flows receiving the stirring action of the first and second stirring means S1 and S2 inside the first and second stirring vessels K1 and K2 as described above. A route indicated by the chain line represented by a symbol C in FIG. 3 schematically illustrates a route through which a molten glass flows. The molten glass exists in the upper portion of the fining passage 10, i.e., a molten glass containing a heterogeneous phase floating on the front surface portion of the melting furnace 2 and the fining vessel 5. A route indicated by the dashed line represented by a symbol D in FIG. 3 schematically illustrates a route through which a molten glass flows. The molten glass exists in the lower portion of the fining passage 10, i.e., a molten glass containing a heterogeneous phase sinking in the bottom portion of the melting furnace 2 and the fining vessel 5.

As can be understood from FIG. 3, the molten glass which exists in the upper portion of the fining passage 10 first flows into the first stirring vessel K1 from the upper portion of the first inflow opening M1 to flow downward through the center portion (portion around the central axis). Then, the molten glass flows out of the lower portion of the first outflow opening N1 to flow obliquely upward through the vicinity of the lower portion of the first communicating passage R1. Then, the molten glass flows into the second stirring vessel K2 from the lower portion of the second inflow opening M2 to flow downward through the vicinity of the inner peripheral surface, and then flows out of the upper portion of the second outflow opening N2 to flow through the vicinity of the upper surface portion of the cooling passage 7. In contrast, the molten glass which exists in the lower portion of the fining passage 10 first flows into the first stirring vessel K1 from the lower portion of the first inflow opening M1 to flow downward through the vicinity of the inner peripheral surface. Then, the molten glass flows out of the upper portion of the first outflow opening N1 to flow obliquely upward through the vicinity of the upper portion of the first communicating passage R1. Then, the molten glass flows into the second stirring vessel K2 from the upper portion of the second inflow opening M2 to flow downward through the center portion, and then flows out of the lower portion of the second outflow opening N2 to flow through the vicinity of the lower surface portion of the cooling passage 7.

In this case, in the first stirring vessel K1 and the second stirring vessel K2, a molten glass which flows through the center portion from the upward position to the downward position is brought into contact with the first stirring means S1 and the second stirring means S2, which are rotating, to receive a sufficient stirring action. In contrast, since a molten glass which flows through the vicinity of the inner peripheral surface of each of the first stirring vessel K1 and the second stirring vessel K2 from the upward position to the downward position is not brought into contact with the first stirring means S1 and the second stirring means S2, the molten glass is less susceptible to the stirring action. Therefore, the molten glass which exists in the upper portion of the fining passage 10 receives a sufficient stirring action inside the first stirring vessel K1 while flowing along the route indicated by the symbol C (route indicated by the chain line), and simultaneously, the molten glass which exists in the lower portion of the fining passage 10 receives a sufficient stirring action inside the second stirring vessel K2 while flowing along the route indicated by the symbol D (route indicated by the dashed line). Thus, a heterogeneous phase having a low specific gravity which exists on the front surface portion of the molten glass in the melting furnace 2 and the fining vessel 5 is sufficiently stirred inside the first stirring vessel K1 to disappear, whereby the front surface portion of the molten glass becomes homogeneous. Simultaneously, a heterogeneous phase having a high specific gravity which exists on the bottom portion of the molten glass is sufficiently stirred inside the second stirring vessel K2 to disappear, whereby the bottom portion of the molten glass becomes homogeneous. Thus, the molten glass is homogenized therethroughout.

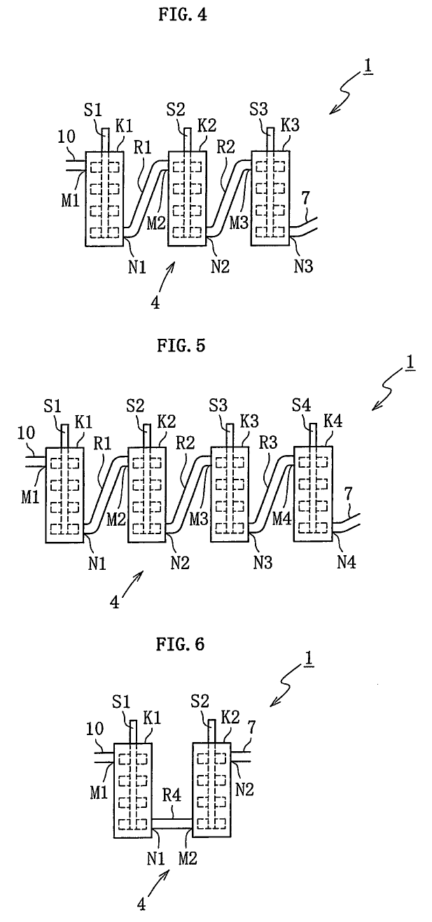

FIG. 4 is an outline front view illustrating an essential part of a molten glass supply apparatus according to Second Embodiment of the present invention. The molten glass supply apparatus 1 according to Second Embodiment is different from the molten glass supply apparatus 1 according to First Embodiment in that, in addition to the first stirring vessel K1 and the second stirring vessel K2, a third stirring vessel K3 whose dimension, shape, and internal structure are the same as those in the first stirring vessel K1 and the second stirring vessel K2 is provided at the downstream side on the way of the supply passage 4 and the cooling passage 7 is communicated to the downstream side of the third stirring vessel K3. In detail, the lower portion (bottom end of the peripheral wall) of the second stirring vessel K2 and the upper portion (top end of the peripheral wall) of the third stirring vessel K3 are connected to each other through a second communicating passage R2 and the cooling passage 7 is connected to the lower portion (bottom end of the peripheral wall) of the third stirring vessel K3. Therefore, the molten glass which has flowed out through the second outflow opening N2 of the second stirring vessel K2 flows obliquely upward through the second communicating passage R2 to pass therethrough. Then, the molten glass flows into the third stirring vessel K3 from the second communicating passage R2 through an inflow opening M3 formed in the upper portion of the third stirring vessel K3. The molten glass flows downward through the inside of the third stirring vessel K3, and then flows out to the cooling passage 7 through a third outflow opening N3 formed in the lower portion of the third stirring vessel K3.

Also in the case where a sheet glass as a glass formed article is produced using the molten glass supply apparatus 1 according to Second Embodiment, a melting step, a stirring step, and a forming step are conducted in the same manner as in First Embodiment described above. In the stirring step, the molten glass is stirred by the first stirring means S1 and the second stirring means S2, which are rotating, inside the first stirring vessel K1 and the second stirring vessel K2 in the same manner as in First Embodiment described above. Simultaneously, the stirred molten glass is stirred by a third stirring means S3, which is rotating, inside the third stirring vessel K3. With reference to the results of the simulation experiment illustrated in FIG. 3, the manner of the flow of the molten glass inside the third stirring vessel K3 becomes substantially the same as that inside the first stirring vessel K1. More specifically, among the molten glass which has flowed out of the second outflow opening N2 of the second stirring vessel K2 to flow obliquely upward through the second communicating passage R2, the molten glass which exists in the vicinity of the upper surface portion (upper portion) of the second communicating passage R2 (molten glass which has first existed in the upper portion of the fining passage 10) flows into the third stirring vessel K3 through the upper portion of the third inflow opening M3. Then, the molten glass flows through the center portion from the upward position to the downward position, and then flows out of the lower portion of the third outflow opening N3 to reach the vicinity of the lower portion of the cooling passage 7. In contrast, the molten glass which exists in the vicinity of the lower surface portion (lower portion) of the second communicating passage R2 (molten glass which has first existed in the lower portion of the fining passage 10) flows into the third stirring vessel K3 through the lower portion of the third inflow opening M3. Then, the molten glass flows through vicinity of the inner peripheral portion from the upward position to the downward position, and then flows out of the upper portion of the third outflow opening N3 to reach the vicinity of the upper portion of the cooling passage 7. Therefore, it can be expected that, as compared with the case of First Embodiment, the stirring action, especially the homogenizing effect, to the heterogeneous phase on the front surface portion of the molten glass in the melting furnace 2 and the fining vessel 5 is more appropriately demonstrated.

FIG. 5 is an outline front view illustrating an essential part of a molten glass supply apparatus according to Third Embodiment of the present invention. The molten glass supply apparatus 1 according to Third Embodiment is different from the molten glass supply apparatus 1 according to Second Embodiment in that, in addition to the first, second, and third stirring vessels K1, K2, and K3, a fourth stirring vessel K4 whose dimension, shape, and internal structure are the same as those in the stirring vessels K1, K2, and K3 and the fourth stirring vessel K4 is provided at the downstream side on the way of the supply passage 4 and the cooling passage 7 is communicated to the downstream side of the fourth stirring vessel K4. In detail, the lower portion (bottom end of the peripheral wall) of the third stirring vessel K3 and the upper portion (top end of the peripheral wall) of the fourth stirring vessel K4 are connected to each other through a third communicating passage R3 and the cooling passage 7 is connected to the lower portion (bottom end of the peripheral wall) of the fourth stirring vessel K4. Therefore, the molten glass which has flowed out through the third outflow opening N3 of the third stirring vessel K3 flows obliquely upward through the third communicating passage R3 to pass therethrough. Then, the molten glass flows into the third stirring vessel K3 from the third communicating passage R3 through an inflow opening M4 formed in the upper portion of the fourth stirring vessel K4. The molten glass flows downward through the inside of the fourth stirring vessel K4, and then flows out to the cooling passage 7 through a fourth outflow opening N4 formed in the lower portion of the fourth stirring vessel K4.

Also in the case where a sheet glass as a glass formed article is produced using the molten glass supply apparatus 1 according to Third Embodiment, a melting step, a stirring step, and a forming step are conducted in the same manner as in First Embodiment described above. In the stirring step, the molten glass is stirred by the first, second, and third stirring means S1, S2, and S3, which are rotating, inside the first, second, and third stirring vessels K1, K2, and K3 in the same manner as in Second Embodiment described above. Simultaneously, the stirred molten glass is stirred by a fourth stirring means S4, which is rotating, inside the fourth stirring vessel K4. With reference to the results of the simulation illustrated in FIG. 3, the manner of the flow of the molten glass inside the fourth stirring vessel K4 becomes substantially the same as that inside the second stirring vessel K2. More specifically, among the molten glass which has flowed out of the third outflow opening N3 of the third stirring vessel K3 to flow obliquely upward through the third communicating passage R3, the molten glass which exists in the vicinity of the lower surface portion (lower portion) of the third communicating passage R3 (molten glass which has first existed in the upper portion of the fining passage 10) flows into the fourth stirring vessel K4 through the lower portion of the fourth inflow opening M4. Then, the molten glass flows through the inner peripheral portion from the upward position to the downward position, and then flows out of the upper portion of the fourth outflow opening N4 to reach the vicinity of the upper portion of the cooling passage 7. In contrast, the molten glass which exists in the vicinity of the upper surface portion (upper portion) of the third communicating passage R3 (molten glass which has first existed in the lower portion of the fining passage 10) flows into the fourth stirring vessel K4 through the upper portion of the fourth inflow opening M4. Then, the molten glass flows through the center portion from the upward position to the downward position, and then flows out of the lower portion of the fourth outflow opening N4 to reach the vicinity of the lower portion of the cooling passage 7. Therefore, it can be expected that, as compared with the case of Second Embodiment, the stirring action, especially the homogenizing effect, to the heterogeneous phase on the bottom portion of the molten glass in the melting furnace 2 and the fining vessel 5, and as compared with the case of First Embodiment, the stirring action, especially the homogenizing effect, to two heterogeneous phases on the front surface and bottom portions are more appropriately demonstrated.

FIG. 6 is an outline front view illustrating an essential part of a molten glass supply apparatus according to Fourth Embodiment of the present invention. The molten glass supply apparatus 1 according to Fourth Embodiment is different from the molten glass supply apparatus 1 according to First Embodiment described above in that the channel structures around the first stirring vessel K1 and the second stirring vessel K2 are fundamentally different from each other. In detail, the fining passage 10 which leads to the downstream side from the fining vessel 5 is connected to the upper portion (top end of the peripheral wall) of the first stirring vessel K1, the lower portion (bottom end of the peripheral wall) of the first stirring vessel K1 and the lower portion (bottom end of the peripheral wall) of the second stirring vessel K2 are connected to each other through the fourth communicating passage R4, and the upper portion (top end of the peripheral wall) of the second stirring vessel K2 is connected to the cooling passage 7 which leads to the pot. Therefore, the molten glass, which has flowed into the first stirring vessel from the fining passage 10 through the first inflow opening M1 in the upper portion of the first stirring vessel K1, flows downward through the inside of the first stirring vessel K1, and flows out to the fourth communicating passage R4 through the first outflow opening N1 formed in the lower portion of the first stirring vessel K1. The molten glass substantially horizontally flows through the fourth communicating passage R4 to pass therethrough, and then flows into the second stirring vessel K2 from the fourth communicating passage R4 through the second inflow opening M2 in the lower portion of the second stirring vessel K2. Then, the molten glass flowing upward through the inside of the second stirring vessel K2, and then flows out to the cooling passage 7 through the second outflow opening N2 in the upper portion of the second stirring vessel K2.

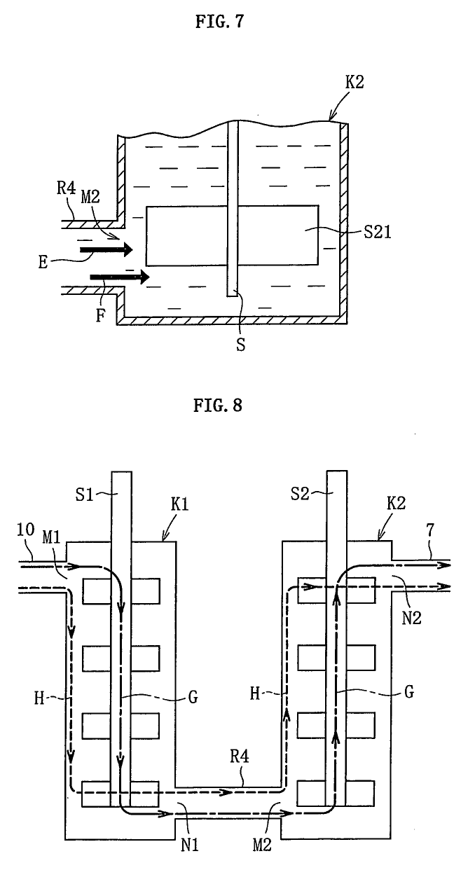

In this case, as illustrated in FIG. 7, the respective means are positioned so that immediately after the molten glass flows into the second stirring vessel K2 from the second inflow opening M2 of the second stirring vessel K2, the molten glass is partially brought into contact with a stirring blade S21 at the bottom stage of the second stirring means S2 through the route indicated by Arrow E. Simultaneously, the remaining portion flows into the lower portion relative to the stirring blade S21 at the bottom stage through the route indicated by Arrow F. It should be noted that the state of the molten glass immediately after flowing into the first stirring vessel K1 from the first inflow opening M1 of the first stirring vessel K1 is the same as the matters previously described with reference to FIG. 2. With respect to the molten glass which flows into the first stirring vessel K1 to flow downward through the inside, the first stirring means S1 is constructed so as to impart resistance directing upward. In contrast, with respect to the molten glass which flows into the second stirring vessel K2 to flow upward through the inside, the second stirring means S2 is constructed so as to impart resistance directing downward.

Also in the case where a sheet glass is produced as a glass formed article using the molten glass supply apparatus 1 according to Fourth Embodiment, a melting step, a stirring step, and a forming step are conducted in the same manner as in First to Third Embodiments described above. In the stirring step, the molten glass is stirred by the first stirring means S1 and the second stirring means S2, which are rotating, while flowing through the inside of the first stirring vessel K1 from the upward position to the downward position and flowing thorough the inside of the second stirring vessel K2 from the downward position to the upward position.

FIG. 8 is a schematic view illustrating the results of the simulation experiment conducted about the state of the molten glass which flows while receiving the stirring action by the first and second stirring means S1 and S2 inside the first and second stirring vessels K1 and K2. A route indicated by the chain line represented by a symbol G in FIG. 8 schematically illustrates a route through which a molten glass, which exists in the upper portion of the fining passage 10, flows. More specifically, the molten glass contains a heterogeneous phase floating on the front surface portion of the melting furnace 2 and the fining vessel 5. A route indicated by the dashed line represented by a symbol H in FIG. 8 schematically illustrates a route through which a molten glass, which exists in the lower portion of the fining passage 10, flows. More specifically, the molten glass contains a heterogeneous phase sinking in the bottom portion of the melting furnace 2 and the fining vessel 5.

As can be understood from FIG. 8, the molten glass which exists in the upper portion of the fining passage 10 first flows into the first stirring vessel K1 from the upper portion of the first inflow opening M1 to flow downward through the center portion. Then, the molten glass flows out of the lower portion of the first outflow opening N1 to flow through the vicinity of the lower portion of the fourth communicating passage R4 in the substantially horizontal direction. Then, the molten glass flows into the second stirring vessel K2 from the lower portion of the second inflow opening M2 to flow upward through the center portion, and then flows out of the upper portion of the second outflow opening N2 to flow through the vicinity of the upper surface portion of the cooling passage 7. In contrast, the molten glass, which exists in the lower portion of the fining passage 10, first flows into the first stirring vessel K1 from the lower portion of the first inflow opening M1 to flow downward through the vicinity of the inner peripheral surface. Then, the molten glass flows out of the upper portion of the first outflow opening N1 to flow through the vicinity of the upper portion of the fourth communicating passage R4 in the substantially horizontal direction. Then, the molten glass flows into the second stirring vessel K2 from the upper portion of the second inflow opening M2 to flow upward through the vicinity of the inner peripheral surface, and then flows out of the lower portion of the second outflow opening N2 to flow through the vicinity of the lower surface portion of the cooling passage 7:

In this case, the molten glass which exists in the upper portion of the fining passage 10 is brought into contact with the first stirring means S1 and the second stirring means S2, which are rotating, to thereby receive a sufficient stirring action inside the first stirring vessel K1 and the second stirring vessel K2 while flowing along the route indicated by a symbol G (route indicated by the chain line). In contrast, the molten glass which exists in the lower portion of the fining passage 10 is less susceptible to a stirring action while flowing along the route indicated by a symbol H (route indicated by the dashed line) because the molten glass is not brought into contact with the first stirring means S1 and the second stirring means S2. Thus, when especially a heterogeneous phase having a low specific gravity which exists on the front surface portion of the molten glass in the melting furnace 2 and the fining vessel 5 becomes a problem, the heterogeneous phase on the front surface portion is sufficiently stirred inside the first and second stirring vessels K1 and K2 to disappear, whereby the front surface portion of the molten glass becomes homogeneous.

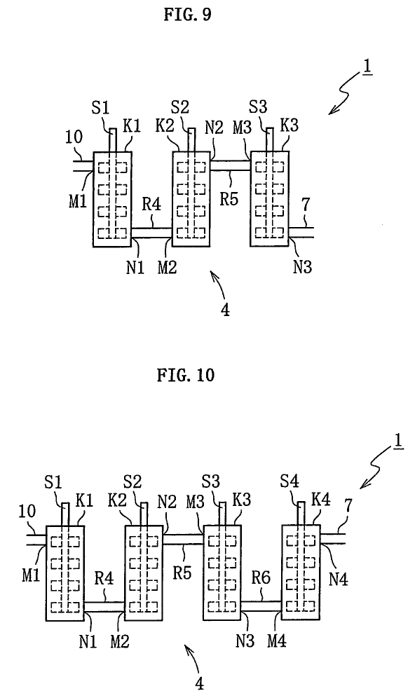

FIG. 9 is an outline front view illustrating an essential part of a molten glass supply apparatus according to Fifth Embodiment of the present invention. The molten glass supply apparatus 1 according to Fifth Embodiment is different from the molten glass supply apparatus 1 according to Fourth Embodiment in that, in addition to the first stirring vessel K1 and the second stirring vessel K2, a third stirring vessel K3 whose dimension, shape, and internal structure are the same as those in the first stirring vessel K1 and the second stirring vessel K2 is provided at the downstream side on the way of the supply passage 4 and the cooling passage 7 is communicated to the downstream side of the third stirring vessel K3. In detail, the upper portion (top end of the peripheral wall) of the second stirring vessel K2 and the upper portion (top end of the peripheral wall) of the third stirring vessel K3 are connected to each other through a fifth communicating passage R5 and the cooling passage 7 is connected to the lower portion (bottom end of the peripheral wall) of the third stirring vessel K3. Therefore, the molten glass which has flowed out through the second outflow opening N2 of the second stirring vessel K2 flows through the fifth communicating passage R5 in the substantially horizontal direction to pass therethrough. Then, the molten glass flows into the third stirring vessel K3 through the inflow opening M3 formed in the upper portion of the third stirring vessel K3 from the fifth communicating passage R5. The molten glass flows downward through the inside of the third stirring vessel K3, and then flows out to the cooling passage 7 through the third outflow opening N3 formed in the lower portion of the third stirring vessel K3.

Also in the case where a sheet glass as a glass formed article is produced using the molten glass supply apparatus 1 according to Fifth Embodiment, a melting step, a stirring step, and a forming step are conducted in the same manner as in First to Third Embodiments described above. In the stirring step, the molten glass is stirred by the first stirring means S1, the second stirring means S2, and the third stirring means S3, which are rotating, while flowing through the inside of the first stirring vessel K1 from the upward position to the downward position, flowing through the inside of the second stirring vessel K2 from the downward position to the upward position, and flowing through the inside of the third stirring vessel K3 from the upward position to the downward position. With reference to the results of the simulation experiment illustrated in FIG. 8, the manner of the flow of the molten glass inside the third stirring vessel K3 becomes substantially the same as that inside the first stirring vessel K1. Therefore, it can be expected that, as compared with the case of Fourth Embodiment, when especially the heterogeneous phase on the front surface portion of the molten glass in the melting furnace 2 and the fining vessels becomes a problem, the stirring action, especially the homogenizing action, to the heterogeneous phase is appropriately demonstrated.

FIG. 10 is an outline front view illustrating an essential part of a molten glass supply apparatus according to Sixth Embodiment of the present invention. The molten glass supply apparatus 1 according to Sixth Embodiment is different from the molten glass supply apparatus 1 according to Fifth Embodiment in that, in addition to the first stirring vessel K1, the second stirring vessel K2, and the third stirring vessel K3, a fourth stirring vessel K4 whose dimension, shape, and internal structure are the same as those in the first stirring vessel K1 and the second stirring vessel K2 and the third stirring vessel K3 is provided at the downstream side on the way of the supply passage 4 and the cooling passage 7 is communicated to the downstream side of the fourth stirring vessel K4. In detail, the lower portion (bottom end of the peripheral wall) of the third stirring vessel K3 and the lower portion (bottom end of the peripheral wall) of the fourth stirring vessel K4 are connected to each other through the sixth communicating passage R6 and the cooling passage 7 is connected to the upper portion (top end of the peripheral wall) of the fourth stirring vessel K4. Therefore, the molten glass which has flowed out through the third outflow opening N3 of the third stirring vessel K3 flows through the sixth communicating passage R6 in the substantially horizontal direction to pass therethrough. Then, the molten glass flows into the fourth stirring vessel K4 through the inflow opening M4 formed in the lower portion of the fourth stirring vessel K4 from the sixth communicating passage R6. The molten glass flows upward through the inside of the fourth stirring vessel K4, and then flows out to the cooling passage 7 through the fourth outflow opening N4 formed in the upper portion of the fourth stirring vessel K4.

Also in the case where a sheet glass as a glass formed article is produced using the molten glass supply apparatus 1 according to Sixth Embodiment, a melting step, a stirring step, and a forming step are conducted in the same manner as in First to Third Embodiments described above. In the stirring step, the molten glass is stirred by the first stirring means S1, the second stirring means S2, the third stirring means S3, and the fourth stirring means S4, which are rotating, while flowing through the inside of the first stirring vessel K1 from the upward position to the downward position, flowing through the inside of the second stirring vessel K2 from the downward position to the upward position, flowing through the inside of the third stirring vessel K3 from the upward position to the downward position, and flowing through the inside of the fourth stirring vessel K4 from the downward position to the upward position. With reference to the results of the simulation experiment illustrated in FIG. 8, the manner of the flow of the molten glass inside the fourth stirring vessel K4 becomes substantially the same as that inside the second stirring vessel K2. Therefore, it can be expected that, as compared with the case of Fifth Embodiment, when especially the heterogeneous phase on the front surface portion of the molten glass in the melting furnace 2 and the fining vessel becomes a problem, the stirring action, especially the homogenizing action, to the heterogeneous phase is appropriately demonstrated.

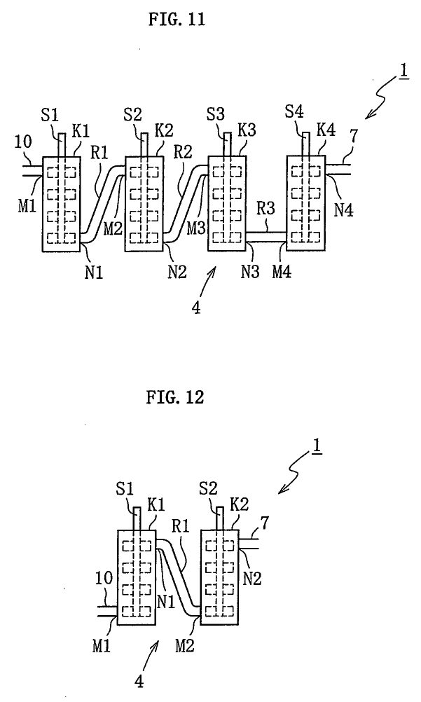

FIG. 11 is an outline front view illustrating an essential part of the molten glass supply apparatus according to Seventh Embodiment of the present invention. The molten glass supply apparatus 1 according to Seventh Embodiment is equivalent to an apparatus containing a combination of a communicating structure of the two stirring vessels K1 and K2 in First Embodiment described above and a communicating structure of the two stirring vessels K1 and K2 in Fourth Embodiment described above. More specifically, in the descending order from the upstream side of the supply passage 4, the fining passage 10 is connected to the first inflow opening M1 in the upper portion of the first stirring vessel K1, the first outflow opening N1 in the lower portion of the first stirring vessel K1 is connected to the second inflow opening M2 in the upper portion of the second stirring vessel K2 through the first communicating passage R1, the second outflow opening N2 in the lower portion of the second stirring vessel K2 is connected to the third inflow opening M3 in the upper portion of the third stirring vessel K3 through the second communicating passage R2, the third outflow opening N3 in the lower portion of the third stirring vessel K3 and the fourth inflow opening M4 in the lower portion of the fourth stirring vessel K4 are connected to each other through the third communicating passage R3, and the cooling passage 7 is connected to the fourth outflow opening N4 in the upper portion of the fourth stirring vessel K4.

Also in the case where a sheet glass as a glass formed article is produced using the molten glass supply apparatus 1 according to Seventh Embodiment, a melting step, a stirring step, and a forming step are conducted in the same manner as in First Embodiment described above. In the stirring step, the molten glass is stirred by the first stirring means S1, the second stirring means S2, the third stirring means S3, and the fourth stirring means 4, which are rotating, while flowing through the inside of the first, second, and third stirring vessels K1, K2, and K3 from the upward position to the downward position, flowing through the inside of the fourth stirring vessel K4 from the downward position to the upward position. Therefore, in this case, it can be expected that, as compared with the case of Fourth Embodiment, the stirring action, especially the homogenizing action, to the heterogeneous phases not only on the front surface portion of the molten glass in the melting furnace 2 and the fining vessel but also on the bottom portion are appropriately demonstrated.

FIG. 12 is an outline front view illustrating an essential part of the molten glass supply apparatus according to Eighth Embodiment of the present invention. The molten glass supply apparatus 1 according to Eighth Embodiment is different from the molten glass supply apparatus 1 according to First Embodiment described above in that the channel structure is changed so that the flow of the molten glass in the first stirring vessel K1 and the second stirring vessel K2 directs from the downward position to the upward position. More specifically, in the descending order from the upstream side of the supply passage 4, the fining passage 10 is connected to the first inflow opening M1 formed in the lower portion of the first stirring vessel K1, the first outflow opening N1 formed in the upper portion of the first stirring vessel K1 is connected to the second inflow opening M2 formed in the lower portion of the second stirring vessel K2 through the first communicating passage R1, and the cooling passage 7 is connected to the second outflow opening N2 formed in the upper portion of the second stirring vessel K2.

Also in the case where a sheet glass as a glass formed article is produced using the molten glass supply apparatus 1 according to Eighth Embodiment, a melting step, a stirring step, and a forming step are conducted in the same manner as in First Embodiment described above. In the stirring step, the molten glass is stirred by the first stirring means S1 and the second stirring means S2, which are rotating, while flowing through both the insides of the first stirring vessel K1 and the second stirring vessel K2 from the downward position to the upward position. Therefore, also with such a structure, it can be expected that, the stirring action, especially the homogenizing effect, to the heterogeneous phase on the front surface portion of the molten glass and the heterogeneous phase on the bottom portion of the molten glass in the melting furnace 2 and the fining vessel 5 is appropriately demonstrated as the same as in First Embodiment described above. It should be noted that the third stirring vessel may be added and communicated and the fourth stirring vessel may be added and communicated in the same manner as in the communicating structure of the first and second stirring vessels K1 and K2 in Eighth Embodiment, or the communicating structure of the two stirring vessels K1 and K2 in Eighth Embodiment and the communicating structure of the two stirring vessels K1 and K2 in First Embodiment described above or the communicating structure of the two stirring vessels K1 and K2 in Fourth Embodiment may be combined.

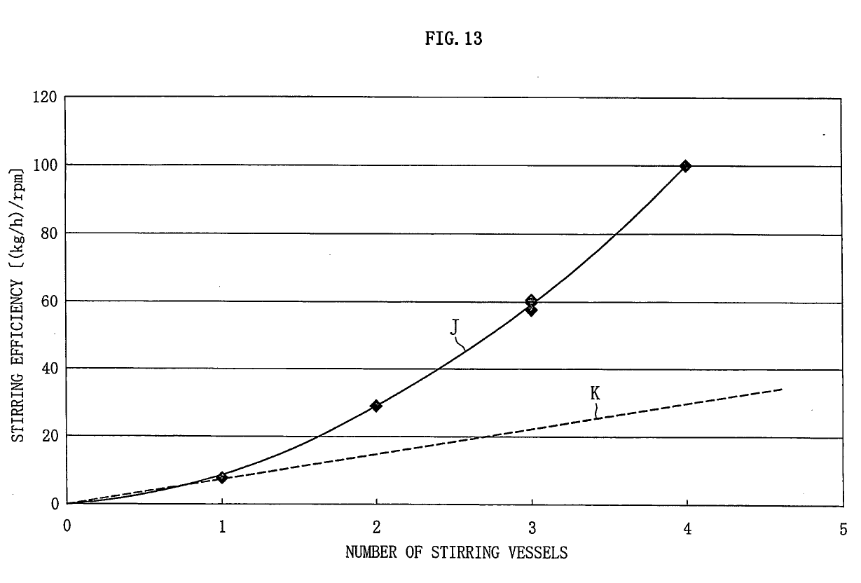

FIG. 13 is a graph illustrating the stirring efficiency when the number of the stirring vessels in the above-described embodiments is two to four. Here, the stirring efficiency refers to a value obtained by dividing the flow amount (kg/h) per means time of the molten glass which flows through the supply passage (inside of each stirring vessel) by the average rotation number (rpm) of each stirring means (each stirrer) rotating inside each stirring vessel. Therefore, the stirring efficiency serves as an index for ascertaining the flow amount of molten glass which can receive the stirring action (homogenization action) per rotation of each stirring means in each stirring vessel. The characteristic curve J indicated by the solid line in FIG. 13 shows the change in the actual stirring efficiency based on the number of the stirring vessels. In contrast, the straight line K indicated by the dashed line in FIG. 13 shows the case where it is assumed that the stirring efficiency increases in proportion to the number of the stirring vessels. As can be understood from the characteristic curve J in FIG. 13, the actual stirring efficiency when the number of the stirring vessels is two is about three times that when the number of the stirring vessels is one; the actual stirring efficiency when the number of the stirring vessels is three is about six or seven times that when the number of the stirring vessels is one; and the actual stirring efficiency when the number of the stirring vessels is four is about ten or eleven times that when the number of the stirring vessels is one. Thus, the stirring efficiency does not increase in proportion to the number of the stirring vessels, and the stirring efficiency increases at a larger proportion. Therefore, when the number of the stirring vessels is controlled to at least 2 to 4 as in the above-described embodiments, the molten glass can be efficiently stirred and homogenized.

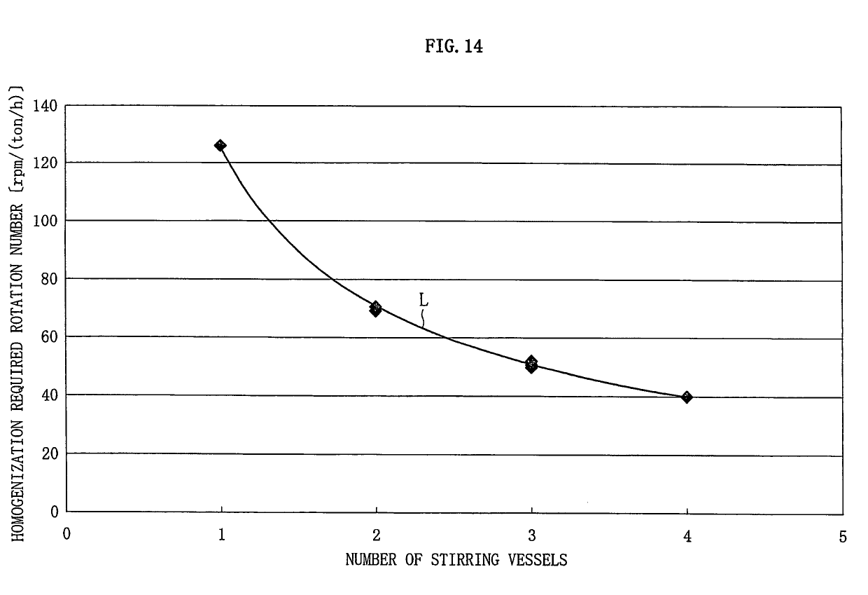

FIG. 14 is a graph illustrating the homogenization required rotation number when the number of the stirring vessels is two to four in the above-described embodiments. Here, the homogenization required rotation number refers to a rotation number (rpm) of the stirring means required in order to sufficiently stir (homogenize) the molten glass without the stirring means (stirrer) of the stirring vessel being susceptible to inappropriate resistance, when it is attempted to flow the molten glass having a flow amount of 1 ton/h. It should be noted that the rotation number of the stirring means as used herein should be understood as a total value of the rotation number of each stirring means of each stirring vessel. The characteristic curve L illustrated in FIG. 14 shows the relationship between the number of the stirring vessels and the homogenization required rotation number. As is clear from the characteristic curve L, with increase in the number of the stirring vessels, homogenization required rotation number decreases, and the rotation number of each stirring means can be considerably reduced. Therefore, when the number of the stirring vessels is controlled to at least 2 to 4 as in each embodiment described above, inappropriate resistance does not act on the stirring means of each stirring vessel and a defect that the stirring blade is chipped and the chipped portion is mixed in a molten glass as a platinum foreign matter.

Moreover, since a plurality of stirring vessels, which are provided separately and independently, are disposed adjacent to each other in the upstream and downstream directions, each stirring vessel can be independently dealt with, and thus maintenance inspection, repair, or exchanging, etc., can be conducted easily and simply. Further, also when controlling the temperature of the stirring vessel so as to appropriately control resistance which acts on the stirring blade from a molten glass, the stirring portion in each vessel is less susceptible to influences of other portions, and the temperature control, especially the viscosity control, of the molten glass which flows through the stirring vessel can be readily and properly conducted.

The molten glass supply apparatus according to the above-described embodiments can be effectively applied to the case where a sheet glass for use in a glass panel for liquid crystal displays by an overflow down-draw process. Other forming processes other than the overflow down-draw process may be employed, and a glass formed article can be applied to a case where forming a sheet glass for use in a glass panel for other flat panel displays such as electroluminescence display and plasma display, a cover glass for various image sensors, such as a charge-coupled device (CCD), an equal-size contact solid-state image sensor (CIS), and a CMOS image sensor, and a laser diode; and a glass substrate for a hard disk and a filter.

On the way of the supply passage according to the above-described embodiments, two to four stirring vessels are disposed adjacent to each other in the upstream and downstream directions, and five or more stirring vessels may be disposed adjacent to each other in the upstream and downstream directions. In detail, five or more stirring vessels may be provided only with the communicating structure illustrated in FIG. 1, 4, or 5. Moreover, five or more stirring vessels may be provided only with the communicating structure illustrated in FIG. 6, 9, or 10, or, five or more stirring vessels may be provided by suitably selecting from the two kinds of communicating structures illustrated in FIG. 11 and the communicating structure illustrated in FIG. 12 for combination. In this case, it is preferred to control the number of the stirring vessels to at least two, at least three, at least four, and at least five according to the flow amount of the molten glass which flows the supply passage.

In the above-described embodiments, the molten glass supply apparatus for use in producing the glass formed article made of a high viscosity glass is described. The present invention can be similarly applied to a molten glass supply apparatus for use in producing a glass formed article made of a low viscosity glass such as an optical glass, a plate glass for windows, a bottle, and tableware, which have been conventionally used.

1. A molten glass supply apparatus, comprising:
a melting furnace serving as a supply source of a molten glass; and
a supply passage for supplying a molten glass which has flowed out of the melting furnace to a forming device, wherein:
the molten glass has such a property that a temperature equivalent to a viscosity of 1,000 poise is 1,350° C. or higher; and
a plurality of stirring vessels for conducting homogenization are disposed adjacent to each other in an upstream direction and in a downstream direction on the way of the supply passage.

2. A molten glass supply apparatus, comprising:
a melting furnace serving as a supply source of a molten glass; and
a supply passage for supplying a molten glass which has flowed out of the melting furnace to a forming device, wherein:
the molten glass has such a property that a temperature equivalent to a viscosity of 1,000 poise is 1,350° C. or higher; and
a plurality of stirring vessels, which are provided separately and independently, are disposed adjacent to each other in an upstream direction and in a downstream direction on the way of the supply passage.

3. A molten glass supply apparatus according to claim 1, wherein all of the plurality of stirring vessels are structured so that a molten glass immediately after flowing into the stirring vessel from an inflow opening of the stirring vessel is brought into contact with a stirring blade accommodated in the stirring vessel.

4. A molten glass supply apparatus according to claim 3, wherein a part of the molten glass immediately after flowing into the stirring vessel from the inflow opening is brought into contact with the stirring blade, and a remaining portion of the molten glass flows into a portion opposite to a forward direction of flow of the molten glass rather than the stirring blade.

5. A molten glass supply apparatus according to claim 1, wherein all of the plurality of stirring vessels are constructed so as to impart resistance opposite to the flow in the forward direction of the molten glass by the stirring blade accommodated in the stirring vessel.

6. A molten glass apparatus according to claim 1, wherein a temperature of the molten glass which flows through all of the insides of the plurality of stirring vessels is 1,350 to 1,550° C.

7. A molten glass apparatus according to claim 1, wherein a viscosity of the molten glass which flows through all of the insides of the plurality of stirring vessels is 300 to 7,000 poise.

8. A molten glass supply apparatus according to claim 1, wherein a sheet glass produced with the forming device is used in a state where both front and rear surfaces are not polished.

9. A process for production of a glass formed article, comprising the steps of:
melting a high viscosity glass having a property that a temperature equivalent to a viscosity of 1,000 poise is 1,350° C. or higher in a melting furnace;
stirring the molten glass by causing the molten glass to flow into and pass through a stirring vessel placement portion which is provided on the way of a supply passage and in which a plurality of stirring vessels for conducting homogenization are disposed adjacent to each other at an upstream side and at a downstream side, when the molten glass flows through the supply passage which leads from the melting furnace to a forming device at a downstream side of the melting furnace; and
forming the molten glass, which has been stirred and supplied to the forming device, into a glass formed article.

10. A process for production of a glass formed article, comprising the steps of:
melting a high viscosity glass having a property that a temperature equivalent to a viscosity of 1,000 poise is 1,350° C. or higher in a melting furnace;
stirring the molten glass by causing the molten glass to flow into and pass through a stirring vessel placement portion which is provided on the way of a supply passage and in which a plurality of stirring vessels, which are provided separately and independently, are disposed adjacent to each other at an upstream side and at a downstream side, when the molten glass flows through the supply passage which leads from the melting furnace to a forming device at a downstream side of the melting furnace; and
forming the molten glass, which has been stirred and supplied to the forming device, into a glass formed article.

11. A molten glass supply apparatus, comprising:
a melting furnace serving as a supply source of a molten glass; and
a supply passage for supplying a molten glass which has flowed out of the melting furnace to a forming device,
a plurality of stirring vessels being disposed adjacent to each other in an upstream direction and in an downstream direction on the way of the supply passage;
among at least two adjacent stirring vessels, a stirring vessel at an upstream side has an inflow opening at one of an upper portion and a lower portion and an outflow opening at another side,
an inflow opening and an outflow opening of a stirring vessel at a downstream side being formed so that upper and lower portions are the same as in the stirring vessel at the upstream side; and
an outflow opening of the stirring vessel at the upstream side being connected to an inflow opening of the stirring vessel at the downstream side whose upper and lower portions are upside-down to the outflow opening through a communicating passage.

12. A molten glass supply apparatus according to claim 11, wherein the outflow opening formed in the lower portion of the stirring vessel at the upstream side is connected to the inflow opening formed in the upper portion of the stirring vessel at the downstream side through the communicating passage.

13. A molten glass supply apparatus according to claim 11, wherein all of the plurality of stirring vessels are provided separately and independently.

14. A molten glass supply apparatus according to claim 11, wherein all of the plurality of stirring vessels conduct homogenization.

15. A molten glass supply apparatus according to claim 11, wherein, in all of the plurality of stirring vessels, an inner peripheral surface is formed of a cylindrical peripheral wall portion and a bottom wall portion which form a cylindrical surface, and an outer peripheral end of a stirring blade accommodated in the stirring vessel is close to the inner peripheral surface.

16. A molten glass supply apparatus according to claim 11, wherein a sheet glass formed with the forming device is used in a state where both front and rear surfaces are not polished.

17. A molten glass supply apparatus according to claim 11, wherein the molten glass has a property that a temperature equivalent to a viscosity of 1,000 poise is 1,350° C. or higher.

18. A process for production of a glass formed article, comprising the steps of:
melting a glass raw material in a melting furnace;
stirring the molten glass by a stirring vessel on the way of a supply passage which leads from the melting furnace to a forming device at a downstream side of the melting furnace; and
forming the molten glass, which has been stirred and supplied to the forming device, into a glass formed article; wherein
the molten glass is stirred by causing the molten glass to flow into and pass through a stirring vessel placement position on the way of a supply passage, in the stirring vessel placement position, a plurality of stirring vessels being disposed adjacent to each other in an upstream direction and in a downstream direction among at least two adjacent stirring vessels, a stirring vessel at an upstream side having an inflow opening at one of an upper portion and a lower portion and an outflow opening at another side, an inflow opening and an outflow opening of a stirring vessel at a downstream side being formed so that upper and lower portions are the same as in the stirring vessel at the upstream side, and the outflow opening of the stirring vessel at the upstream side being connected to the inflow opening of the stirring vessel at the downstream side in which upper and lower portions are upside-down to the outflow opening through a communicating passage.

19. A process for production of a glass formed article according to claim 18, wherein, in the stirring vessel placement position on the way of the supply passage, the outflow opening formed in the lower portion of the stirring vessel at the upstream side is connected to the inflow opening formed in the upper portion of the stirring vessel at the downstream side through a communicating passage.

20. A process for production of a glass formed article according to claim 18, wherein the molten glass has a property that a temperature equivalent to a viscosity of 1,000 poise is 1,350° C. or higher.

21. A molten glass supply apparatus, comprising:
a melting furnace serving as a supply source of a molten glass;
a supply passage for supplying a molten glass which has flowed out of the melting furnace to a forming device;
a plurality of stirring vessels, which are provided separately and independently, being disposed adjacent to each other in an upstream direction and in a downstream direction on the way of the supply passage;
among at least two adjacent stirring vessels, a stirring vessel at an upstream side having an inflow opening at one of an upper portion and a lower portion and an outflow opening at another side;
an inflow opening and an outflow opening of a stirring vessel at a downstream side being formed in such a manner as to be upside-down to the stirring vessel at the upstream side; and
the outflow opening of the stirring vessel at the upstream side being connected to the inflow opening of the stirring vessel at the downstream side in which upper and lower portions are the same as in the outflow opening through a communicating passage.

22. A molten glass supply apparatus according to claim 21, wherein the outflow opening formed in the lower portion of the stirring vessel at the upstream side is connected to the inflow opening formed in the lower portion of the stirring vessel at the downstream side through the communicating passage.

23. A molten glass supply apparatus according to claim 21, wherein all of the plurality of stirring vessels conduct homogenization.

24. A molten glass supply apparatus according to claim 21, wherein, in all of the plurality of stirring vessels, an inner peripheral surface is formed of a cylindrical peripheral wall portion and a bottom wall portion which form a cylindrical surface, and an outer peripheral end of a stirring blade accommodated in the stirring vessel is close to the inner peripheral surface.

25. A molten glass supply apparatus according to claim 21, wherein a sheet glass formed with the forming device is used in a state where both front and rear surfaces are not polished.

26. A molten glass supply apparatus according to claim 21, wherein the molten glass has a property that a temperature equivalent to a viscosity of 1,000 poise is 1,350° C. or higher.

27. A process for production of a glass formed article, comprising the steps of:
melting a glass raw material in a melting furnace;
stirring the molten glass by a stirring vessel on the way of a supply passage which leads from the melting furnace to a forming device at a downstream side of the melting furnace; and
forming the molten glass, which has been stirred and supplied to the forming device, into a glass formed article; wherein
the molten glass is stirred by causing the molten glass to flow into and pass through a stirring vessel placement position on the way of a supply passage, in the stirring vessel placement position, a plurality of stirring vessels, which are provided separately and independently, being disposed adjacent to each other in an upstream direction and in a downstream direction among at least two adjacent stirring vessels, a stirring vessel at an upstream side having an inflow opening at one of an upper portion and a lower portion and an outflow opening at the other side, an inflow opening and an outflow opening of a stirring vessel at a downstream side being formed so that upper and lower portions are upside-down to the stirring vessel at the upstream side, and the outflow opening of the stirring vessel at the upstream side being connected to the inflow opening of the stirring vessel at the downstream side in which upper and lower portions are the same as in the outflow opening through a communicating passage.

28. A process for production of a glass formed article according to claim 27, wherein, in the stirring vessel placement position on the way of the supply passage, the outflow opening formed in the lower portion of the stirring vessel at the upstream side is connected to the inflow opening formed in the upper portion of the stirring vessel at the downstream side through a communicating passage.

29. A process for production of a glass formed article according to claim 27, wherein the molten glass has a property that a temperature equivalent to a viscosity of 1,000 poise is 1,350° C. or higher.
